(19) United States
(12) Patent Application Publication
(10) Pub. No.: US 2020/0250684 A1
(43) Pub. Date: Aug. 6, 2020

(54) SYSTEM AND METHOD FOR PROCESSING A PROOF OF PROVENANCE TRANSACTION

(71) Applicant: MASTERCARD ASIA/PACIFIC PTE. LTD., Singapore (SG)

(72) Inventors: Tobias Puehse, Singapore (SG); Bensam Joyson, Singapore (SG); Nina Nieuwoudt, Greenwich, CT (US)

(21) Appl. No.: 16/738,137

(22) Filed: Jan. 9, 2020

(30) Foreign Application Priority Data
Feb. 4, 2019 (SG) 10201901025S

(51) Int. Cl. G06Q 30/00; G06Q 20/40

(52) U.S. Cl. CPC G06Q 30/018; G06Q 20/40

(57) ABSTRACT

The present disclosure provides a payment network server for processing a proof of provenance transaction. The payment network server comprises a processor, a memory in communication with the processor, the memory comprising computer application programs that are executable by the processor, wherein, when the computer application programs are executed by the processor, the processor is configured to: receive a proof of provenance identifier; transmit the proof of provenance identifier to a proof of provenance server; and receive an authorization message indicating an approval or denial of the proof of provenance identifier.

### CROSS-REFERENCE TO RELATED APPLICATION

This application claims the benefit of, and priority to, Singapore Patent Application No. 10201901025S filed on Feb. 4, 2019. The entire disclosure of the above application is incorporated herein by reference.

### FIELD

The present disclosure relates generally to proof of provenance and, in particular, to implementing a system to process proof of provenance transactions. The present disclosure also relates to processing a payment transaction together with determining proof of provenance.

### BACKGROUND

This section provides background information related to the present disclosure which is not necessarily prior art.

The benefits of determining provenance is well-known. For example, products in a typical supply chain follow a path of transit from their source at the point of origin or manufacture, to wholesale distributors, then to retail supply chain locations, and eventually to an end-user. At each step in the supply chain, there is value in confirming that the product is what the seller claims it to be, and that it is an authentic, authorized product, as opposed to a counterfeit or a grey market good. Similarly, it would be valuable, as a consumer, to be able to confirm that a provider of services is qualified or otherwise authorized to provide such services.

In the case of counterfeit goods, sellers face the risk of counterfeit goods being returned, the high cost of brand protection activities, and expenses incurred with tracking the movement of product on the supply chain and buyers face the risks of buying harmful or inferior products. In the case of services, consumers face the risk that the service provider is not authorized or qualified to provide the offered services.

While attempts have been made to solve the problems associating with unauthorized products and services in commerce, many of these solutions require complex, expensive systems and infrastructure to be developed to provide tracking capabilities.

### SUMMARY

This section provides a general summary of the disclosure, and is not a comprehensive disclosure of its full scope or all of its features. Aspects and embodiments of the disclosure are set out in the accompanying claims.

Disclosed are arrangements which seek to address one or more of the above problems by providing a system for processing a proof of provenance transaction using payment protocols over a payment network. The disclosed arrangements can also be used to process a payment transaction in conjunction with acquiring the proof of provenance of the goods.

The present disclosure enables a user to establish a proof of provenance identity for an item, where the proof of provenance identity is identifiable with an identifier. The system, according to the present disclosure, also manages the proof of provenance identity at a proof of provenance host. When the item is purchased by a customer, the ownership details in the proof of provenance identity is updated so that the customer is listed as the owner of the item.

The system enables a payment network server to process a proof of provenance identifier to verify the authenticity of the item, transfer ownership of the item, and/or register the item.

The present disclosure also provides a proof of provenance account that is being managed by a proof of provenance server. The proof of provenance account provides another layer of managing the proof of provenance identities. The proof of provenance account is associated with a user and stores all the proof of provenance identities that the user owns. Other uses of the proof of provenance account will be discussed below.

According to a first aspect of the present disclosure, there is provided a payment network server for processing a proof of provenance transaction, the payment network server comprising: a processor; a memory in communication with the processor, the memory comprising computer application programs that are executable by the processor, wherein, when the computer application programs are executed by the processor, the processor is configured to: receive a proof of provenance identifier; transmit the proof of provenance identifier to a proof of provenance server; and receive an authorization message indicating an approval or denial of the proof of provenance identifier.

According to a second aspect of the present disclosure, there is provided a method of processing a proof of provenance transaction, comprising: receiving, by a payment network server, a proof of provenance identifier; transmitting, by the payment network server, the proof of provenance identifier to a proof of provenance server; and receiving, by the payment network server, an authorization message indicating an approval or denial of the proof of provenance identifier.

Another aspect of the present disclosure provides a non-transitory computer readable medium, having a program recorded thereon, where the program is configured to make a computer execute a method of processing a proof of provenance transaction, comprising: receiving, by a payment network server, a proof of provenance identifier; transmitting, by the payment network server, the proof of provenance identifier to a proof of provenance server; and receiving, by the payment network server, an authorization message indicating an approval or denial of the proof of provenance identifier.

According to another aspect of the present disclosure, there is provided an apparatus for implementing any one of the aforementioned methods.

According to another aspect of the present disclosure, there is provided a computer program product including a computer readable medium having recorded thereon a computer program for implementing any one of the methods described above.

Other aspects are also disclosed.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure. Some aspects of at least one embodiment of the present disclosure will now be described with reference to the drawings and appendices, in which:

FIG. 1 shows a system to obtain proof of provenance according to an aspect of the present disclosure;

FIGS. 2A and 2B depict a flow diagram of methods of determining proof of provenance using the system of FIG. 1;

FIG. 3 is a flow diagram of a method of obtaining details of a proof of provenance identifier;

FIG. 4 is a flow diagram of a method of updating a proof of provenance account;

FIG. 5 is a flow diagram of a method of updating the details of a proof of provenance identifier;

FIGS. 6A and 6B form a schematic block diagram of a general purpose computer system upon which the payment network server of FIG. 1 can be practiced;

FIG. 6C is a schematic block diagram of a general purpose computer system upon which the proof of provenance server of FIG. 1 can be practiced;

FIG. 6D is a schematic block diagram of a general purpose computer system upon which a combined payment network and proof of provenance server of FIG. 1 can be practiced;

FIG. 7 shows an example of a computing device to realize the payment network server shown in FIG. 1;

FIG. 8 shows an example of a computing device to realize the proof of provenance server shown in FIG. 1; and

FIG. 9 shows an example of a computing device to realize a combined payment network and proof of provenance server shown in FIG. 1.

Corresponding reference numerals indicate corresponding parts throughout the several views of the drawings.

### DETAILED DESCRIPTION

Embodiments will be described, by way of example only, with reference to the drawings. The description and specific examples included herein are intended for purposes of illustration only and are not intended to limit the scope of the present disclosure.

### Terms Description

Payment Transaction—A payment transaction relates to an agreement carried out between a customer and a merchant to exchange assets (i.e., goods or services) for payment.

Payment Account—A payment account is used to provide or receive funds for a payment transaction. Examples of a payment account are a checking account, a savings account, a credit account, a virtual payment account, a payment card, and the like. A payment account is associated with either a customer or a merchant. A payment account associated with a customer is issued by an issuer in a transaction. On the other hand, a payment account associated with a merchant is issued by an acquirer in a transaction.

In some instances, a payment account may be virtual, such as those accounts operated by PayPal®, etc. The payment card refers to any suitable transaction cards, such as credit cards, debit cards, prepaid cards, charge cards, membership cards, promotional cards, frequent flyer cards, identification cards, gift cards, and/or any other device that may hold payment account information, such as mobile phones, Smartphones, personal digital assistants (PDAs), key fobs, and/or computers.

Customer—a customer may be any suitable type of entity associated with a payment account, which may include a person, family, company, corporation, governmental entity, and the like. The term customer is used herein to identify an entity performing a purchase in a payment transaction and providing the funds for the transaction. The customer may also perform a proof of provenance transaction.

Merchant—a merchant may be any suitable type of entity associated with a payment account, which may include a person, family, company, corporation, governmental entity, and the like. The term merchant is used herein to identify an entity performing a sale in a payment transaction and receiving the funds for the transaction.

Transaction credentials—Transaction credentials are credentials provided by either a customer or a merchant to conduct a payment transaction. Examples of the transaction credentials include a payment account, a password associated with the payment account, and any other data that an acquirer provider or an issuer provider needs to authorize a payment transaction.

Proof of Provenance (POP) Transaction—A POP transaction relates to obtaining a POP identity. The POP identity can be obtained by using a payment network server.

A POP identity—an identification relating to the provenance (or authenticity) to enable the authenticity and ownership of the item to be identified.

A POP identity may include any one or more of the following details: a name of an entity; an address of the entity; a description; and a location.

The above details are examples of what a POP identity may include, and a POP identity does not necessarily require any of the above example details. There may be more or less detail in a POP identity.

In one arrangement, a POP identity does not contain any details. In this arrangement, the POP identifier simply indicates that such a POP identifier has been issued by a brand owner.

The POP identity is issued by an entity that is authorized to issue POP identities, such as a manufacturer, a distributor, or a brand owner. In one arrangement, a brand owner or another entity, or a payment network operator, operates a POP host to manage the POP identities.

Once the POP identity is issued, the POP identity is updateable by a payment network server when a transaction to purchase the item is completed.

A POP identifier—a POP identifier is an identifier by which a POP identity can be retrieved. A POP identifier is a unique digital code. In one example, the POP identifier may be a string of numbers and/or letters, such as a 16-digit EMV compatible bank identification number (BIN). The POP identifier may also be a token that is provisioned and processed by a tokenization server.

If the POP identifier is in the form of a BIN, the leading six digits of the POP identifier is the identification number of the proof of provenance server through which the POP identifier is to be processed. The remaining numbers, except the last digit, on the POP identifier are the POP identifier number of a POP identity. The POP identifier may have up to 12 digits. The last digit is the Luhn check digit that is calculated using the Luhn algorithm, which is a checksum formula for validating the POP identifier number.

For example, a POP identifier in the form of a BIN is 111111222222223. These numbers are used for simplicity sake. The leading six digits, which is the number 1, refer to the POP server that is to be used to process the POP identifier. The number 2 is the POP identifier number of a POP identity, while the number 3 is the Luhn check digit.

When the example POP identifier is tokenized, the POP identifier may become 111111xxxxxxxx3, where the letter “x” denotes the tokenized number 2.

In one arrangement, a POP identifier is associated with a Payment Account Reference (PAR) in accordance with the EMVCo Standards. PAR is associated with a POP identifier and its associated tokens provisioned at various interaction points and informs the ownership of a POP identifier to be transferred into a new environment by validating or negating the POP identifier tokens. The use of PAR in transferring ownership will be described below.

The proof of provenance identifier may be provisioned in a label (e.g., a barcode, a QR code, etc.) or an electronic device (e.g., a chip card, a Near Field Communication (NFC) chip, a radiofrequency identification (RFID) chip, etc.) that stores or encodes a POP identifier. The POP identifier may also be encoded and stored in software, hardware, or other suitable machine-readable formats.

The label can be provisioned on a POP tag, which is affixed to the item. The POP identifier can be read from the POP label or electronic device. A device, such as a scanner or an NFC reader, can be used to read the POP label or electronic device.

A POP account—a POP account is an account of a user who is registered at a POP server. The user can be a customer, a merchant, a brand owner, or any third parties (e.g., a courier) who want to use the POP server. In certain circumstances, the POP account is not required to use the POP server. A POP account includes details (e.g., name, address, etc.) of a user.

The POP server manages the POP accounts of users and the interactions between items and users.

User—a user may be any suitable type of entity, which may include a person, family, company, corporation, governmental entity, and the like. The term user is used herein to identify an entity that uses a user device 144A to 144N to access a POP server. The user may also be a customer, a merchant, a brand owner, an acquirer, or an issuer. A user who is registered to the POP server will be called a registered user. A user who is not registered to the POP server will be called a non-registered user. The term user will be used to collectively refer to both registered and non-registered users.

A user may also be a customer or a merchant of a payment transaction.

Payment Network Server—The payment network server is a server that hosts software application programs for processing payment transactions or POP transactions. The payment network server communicates with a token server (if required), and any other servers (e.g., an issuer server, an acquirer server) to facilitate payment transactions. The payment network server communicates with a POP server to facilitate POP transactions. Payment network servers may use a variety of different protocols and procedures in order to process the payment and POP transactions.

Payment transactions that may be performed via a payment network server include product or service purchases, credit purchases, debit transactions, fund transfers, account withdrawals, etc. Payment network servers may be configured to process transactions via cash-substitutes, which may include payment cards, letters of credit, checks, payment accounts, etc. The payment network server is operated by a service provider such as Mastercard®. For example, the payment network server may be Banknet® network operated by Mastercard®. The service provider may be an entity (e.g., a company or organization) who operates to process transactions, clear and settle funds for payments between two entities (e.g., two banks). The payment network server may include one or more computing devices that are used for processing payment transactions.

Item—an item having a proof of provenance identity and an associated proof of provenance identifier. The item may be a physical item (e.g., shoes, a bottle of wine, etc.) or a digital item (e.g., a computer program, a digital image, etc.).

### DETAILED DESCRIPTION

Where reference is made in any one or more of the accompanying drawings to steps and/or features, which have the same reference numerals, those steps and/or features have for the purposes of this description, the same function(s) or operation(s), unless the contrary intention appears.

It is to be noted that the discussions contained in the “Background” section and that above relating to prior art arrangements relate to discussions of devices which form public knowledge through their use. Such should not be interpreted as a representation by the present inventor(s) or the patent applicant that such devices in any way form part of the common general knowledge in the art.

### The POP Transaction System 100

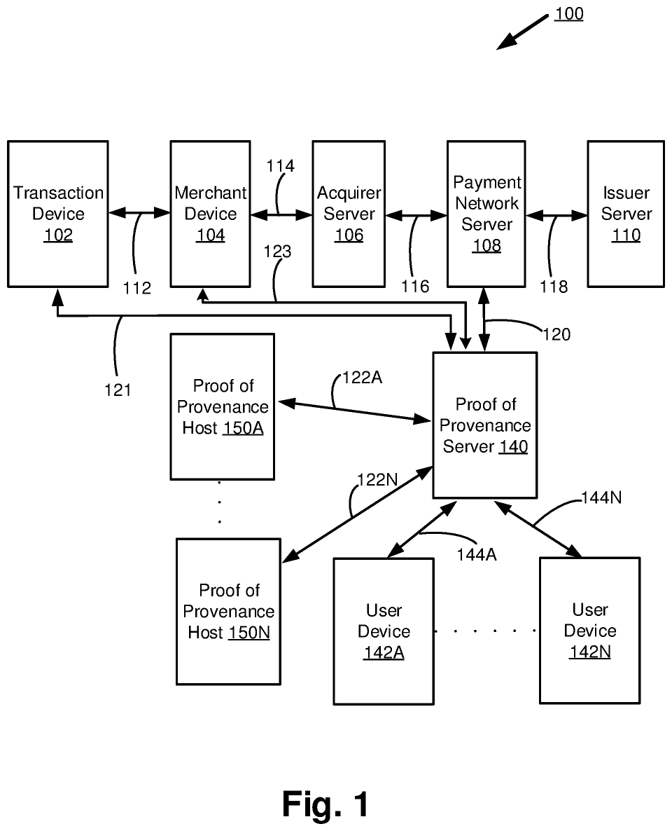

FIG. 1 illustrates a block diagram of a POP transaction system 100 for providing proof of provenance. Further, the system 100 enables a payment transaction for the goods to be processed in conjunction with verifying the provenance of the goods.

The system 100 comprises a transaction device 102, a merchant device 104, an acquirer server 106, a payment network server 108, an issuer server 110, a POP server 140, POP hosts 150A to 150N, and user devices 142A to 142N.

The transaction device 102 is in communication with a merchant device 104 via a connection 112. The connection 112 may be wireless (e.g., via NFC communication, Bluetooth, etc.) or over a network (e.g., the Internet). The transaction device 102 is also in communication with the POP server 140 via a connection 121. The connection 121 may be a network (e.g., the Internet).

The merchant device 104 is in communication with the transaction device 102 as described above. The merchant device 104 is, in turn, in communication with an acquirer server 106 via a connection 114. The merchant device 104 is also in communication with the POP server 140 via a connection 123. The connections 114 and 123 may be a network (e.g., the Internet).

The acquirer server 106, in turn, is in communication with a payment network server 108 via a connection 116. The payment network server 108, in turn, is in communication with an issuer server 110 via a connection 118. The connections 116 and 118 may be a network (e.g., the Internet).

The payment network server 108 is further in communication with the POP server 140 via a connection 120. The connection 120 may be over a network (e.g., a local area network, a wide area network, the Internet, etc.). In one arrangement, the payment network server 108 and the POP server 140 are combined and the connection 120 may be an interconnected bus.

The POP server 140, in turn, is in communication with the POP hosts 150A to 150N via respective connections 122A to 122N. The connections 122A to 122N may be a network (e.g., the Internet).

The POP hosts 150A to 150N are servers. The term host is used herein to differentiate between the POP hosts 150A to 150N and the POP server 140. The POP hosts 150A to 150N are collectively referred to herein as the POP hosts 150, while the POP host 150 refers to one of the POP hosts 150. The POP hosts 150 may be combined with the POP server 140.

User devices 142A to 142N are connected to the POP server 140 via respective connections 144A to 144N. The user devices 142A to 142N are collectively referred to herein as the user devices 142, while the user device 142 refers to one of the user devices 142. The connections 144A to 144N are collectively referred to herein as the connections 144, while the connection 144 refers to one of the connections 144. The connections 144 may be over a network (e.g., the Internet). The user devices 144 may perform the functions of the transaction device 102 or the merchant device 104.

In the illustrative embodiment, each of the devices 102, 104, 142; and the servers 106, 108, 110, 140, and 150 provides an interface to enable communication with other connected devices 102, 104, 142 and/or servers 106, 108, 110, 140, and 150. Such communication is facilitated by an application programming interface (“API”). Such APIs may be part of a user interface that may include graphical user interfaces (GUIs), Web-based interfaces, programmatic interfaces, such as application programming interfaces (APIs) and/or sets of remote procedure calls (RPCs) corresponding to interface elements, messaging interfaces in which the interface elements correspond to messages of a communication protocol, and/or suitable combinations thereof.

Use of the term ‘server’ herein can mean a single computing device or a plurality of interconnected computing devices which operate together to perform a particular function. That is, the server may be contained within a single hardware unit or be distributed among several or many different hardware units.

### The POP Server 140

The POP server 140 is associated with an entity (e.g. a company or organization or moderator of the service). In one arrangement, the POP server 140 is owned and operated by the entity operating the payment network server 108. In such an arrangement, the POP server 140 may be implemented as a part (e.g., a computer program module, a computing device, etc.) of the payment network server 108.

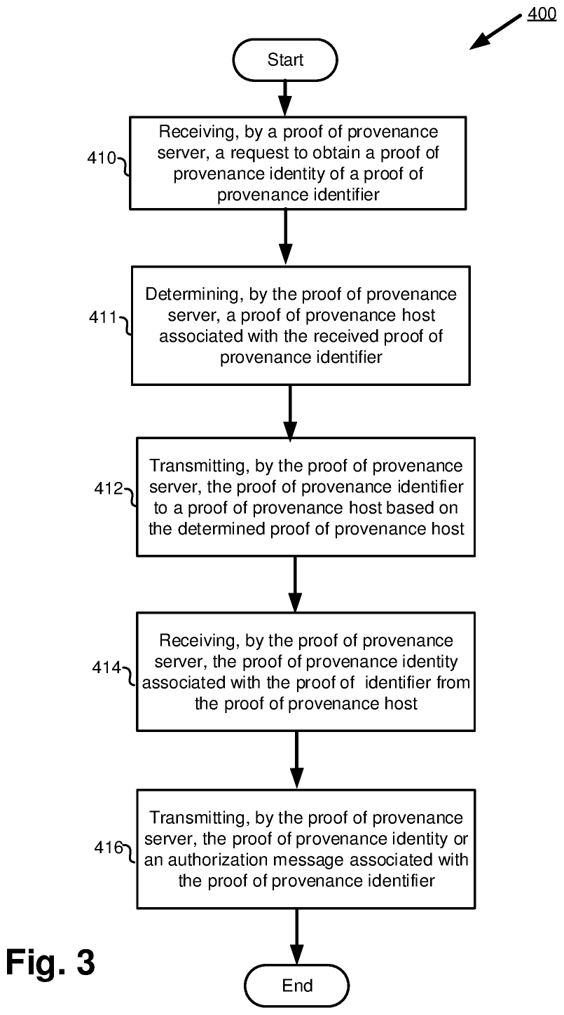

The POP server 140 is configured to receive a POP identifier. The POP server 140 then obtains the POP identity related to the received POP identifier from the POP hosts 150. FIG. 3 shows a flow chart of a method 400 of obtaining the POP identity. As will be discussed below, the method 400 obtains the POP identify of a received POP identifier from the POP host 150.

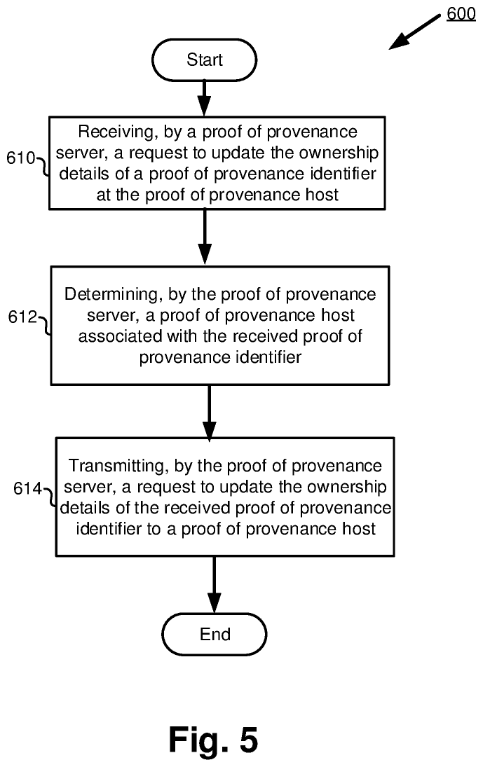

The POP server 140 is further configured to update the POP identity. The updating of the POP identity is discussed in relation to a method 600 (see FIG. 5).

The POP server 140 is also configured to manage the registration of users. A registered user has a POP account (see the discussion above) which includes details of the user. The registration step is called on-boarding. A user may use the user device 142 to perform on-boarding to the POP server 140.

It is not necessary to have a POP account at the POP server 140 to access the functionalities of the POP server 140. However, there are functions that are available to a registered user. These additional functions will be discussed below.

The on-boarding process for a user is performed by the user through one of the user devices 142. In one arrangement, the user downloads an app (which includes the API to interact with the POP server 140) to the user device 142. In another arrangement, the user accesses a website (which includes the API to interact with the POP server 140) on the user device 142. The user is then able to interact with the POP server 140 to register via the user device 142. The user may be a customer or a merchant associated with the transaction device 102 or the merchant device 104, respectively.

Details of the registration include, for example, name of the user, address of the user, user payment account, user devices 142 that are authorized to update the POP account, preferences, items (along with the corresponding proof of provenance identifiers) that the user owns, and the like.

Once on-boarded, the user would have a POP account that stores all the registration details. Adding a proof of provenance identifier to a proof of provenance account is described below in relation to sub-process 500 (see FIG. 5).

### The Transaction Device 102

The transaction device 102 is associated with a customer who is a party to a payment transaction or a POP transaction that occurs between the transaction device 102 and the merchant device 104. The transaction device 102 may be a computing device, such as a desktop computer, an interactive voice response (IVR) system, a smartphone, a laptop computer, a personal digital assistant computer (PDA), a mobile computer, a tablet computer, and the like. The transaction device 102 may also be a payment device, such as a credit card.

The transaction device 102 includes transaction credentials (e.g., a payment account) of a customer to enable the transaction device 102 to be a party to a payment transaction. In one arrangement, the transaction credentials in the transaction device 102 have been tokenized by a token server (not shown) in accordance with EMV Standards.

If the customer has a POP account, the POP account may also be included (i.e., stored) in the transaction device 102. For example, a credit card (which is a transaction device 102) may have the POP account of the customer stored in the credit card. In an alternative arrangement, the POP account belongs to a user (e.g., a parent of the customer) associated with the customer. In one arrangement, the POP account stored in the transaction device 102 has been tokenized by a token server (not shown) in accordance with EMV Standards.

In one example arrangement, the transaction device 102 is a computing device in a watch or similar wearable device and is fitted with a wireless communications interface (e.g., a NFC interface). The transaction device 102 can then electronically communicate with the merchant device 104 to perform a payment transaction or a POP transaction. The customer uses the watch or similar wearable device to perform the payment or POP transaction with the merchant by scanning the watch or wearable device at the merchant device 104. When scanning the watch, the transaction device 102 transmits, to the merchant device 104, the transaction credentials of the customer and, if available, the proof of provenance account in the transaction device 102. This example arrangement is also applicable when the transaction device is a payment device, such as a credit card.

In one arrangement, when the transaction device 102 is a computing device, the transaction device 102 is configured to read, from a POP label or electronic device, a POP identifier. The reading of the POP identifier is as described above. The transaction device 102 then communicates with the POP server 140 to obtain the POP identity of the scanned POP identifier. This function can be performed without having a POP account.

In one arrangement, the transaction device 102 is associated with PAR of the user. PAR is a reference number that is associated with a POP identifier and can be transmitted on transactions involving the transaction device 102. The transaction device 102 can validate the linkage between the POP identifier token and the primary POP identifier via PAR.

### The Merchant Device 104

The merchant device 104 is associated with a merchant who is also a party to the payment or POP transaction that occurs between the transaction device 102 and the merchant device 104. The merchant device 104 may be a point-of-sale (POS) terminal, an automatic teller machine (ATM), a personal computer, a computer server (hosting a website, for example), an IVR system, a land-line telephone, or any type of mobile device, such as a mobile phone, a personal digital assistant (PDA), a laptop computer, a tablet computer, and the like.

The merchant device 104 is configured to process a POP transaction for obtaining a POP identity. To obtain the POP identity, the merchant device 104 first obtains a POP identifier. The POP identifier can be manually entered into the merchant device 104 or automatically read by the merchant device 104. For example, the manual entry can be performed by a merchant using a user device 144 to read a POP label or electronic device to obtain the POP identifier. The merchant then enters the obtained POP identifier into the merchant device 104. In another example, the automatic entry can be performed by the merchant device 104 reading the POP label or electronic device from an item to obtain the POP identifier. The merchant device 104 can then transmit the POP identifier to the POP server 140 via the payment network server 108 to enable the processing of the POP transaction (see steps 218 and 220 of the methods 200A and 200B below).

In one arrangement, the merchant device 104 forwards the obtained POP identifier directly (via connection 123) to the POP server 140 to acquire the POP identity. The POP identity can be shown to customers who are interested in finding out the provenance (or authenticity). The POP identity includes any one of the details of a name of an entity that owns the item; an address of the entity that owns the item; a description of the item; and a location of the item. The POP identity may include other details.

The merchant device 104 is also configured to communicate directly with the POP server 140 to update a POP identity, a POP account of a customer, and a POP account of the merchant. To perform this function, the merchant device 104 is configured to receive customer transaction credentials, a POP account of the customer, a POP account of a registered user associated with the customer, and a POP account of the merchant. For ease of description hereinafter, a proof of provenance of a customer also refers to a proof of provenance of a registered user associated with a customer. The customer transaction details may also include the name of the customer.

To update a POP identity or a POP account of the merchant, the merchant device 104 may also include a POP account of the merchant or a third party associated with the merchant. For example, the merchant device 104 may be associated with only one business having a physical retail store. In such an example, the POP account of the business may be stored in the merchant device 104 to enable the POP account to be automatically added when amending a POP identity or updating the POP account of the merchant. In another example, the merchant device 104 may be provided by an entity such that the merchant device 104 can be used by other third parties to sell goods. In this other example, the POP account of a third party can be manually added into the merchant device 104 when amending a POP identity or updating the POP account of the third party.

Hereinafter, the term “merchant” refers to a merchant and any third party associated with merchant that sell goods or services via the merchant device 104. Therefore, the POP account of a merchant refers to both the POP account of a merchant and the POP account of a third party (e.g., a manufacturer) associated with the merchant.

The POP account is then transmitted directly to the POP server 140 via connection 123 to amend the POP identity or update the relevant POP account. The use of the merchant's POP account will be described below. In one arrangement, the POP account stored in the merchant device 104 has been tokenized by a token server (not shown) in accordance with EMV Standards.

The merchant device 104 is also configured to process a payment transaction. The payment transaction involves a transaction request message (which includes, among others, a transaction amount, transaction credentials of a customer and merchant, and the like), which is generated and transmitted by the merchant device 104 to the acquirer server 106. The transaction request message may also be tokenized in accordance with EMV Standards.

### The Acquirer Server 106

The acquirer server 106 is associated with an acquirer who may be an entity (e.g., a company or organization) which issues (e.g., establishes, manages, administers) a payment account (e.g., a financial bank account) of the merchant. Examples of the acquirer include a bank and/or other financial institution. As discussed above, the acquirer server 106 may include one or more computing devices that are used to establish communication with another server (e.g., the payment network server 108) by exchanging messages with and/or passing information to the other server. The acquirer server 106 forwards the transaction request message of a payment transaction, or the POP identifier of a POP transaction, to the payment network server 108.

### The Payment Network Server 108

The payment network server 108 is as described above in the terms description section.

The payment network server 108 is configured to process a POP transaction by forwarding the POP identifier (and any relevant POP account) to the POP server 140, which in turn returns the POP identity relating to the POP identifier. The method 400 in FIG. 3 and associated description discuss how the POP server 140 obtains the POP identity from a proof of provenance identifier.

The payment network server 108 processes a payment transaction before or after a POP transaction as described in the method 200A and 200B respectively.

### The Issuer Server 110

The issuer server 110 is associated with an issuer and may include one or more computing devices that are used to perform a payment transaction. The issuer may be an entity (e.g., a company or organization) which issues (e.g., establishes, manages, administers) a transaction credential or a payment account (e.g., a financial bank account) associated with the owner of the transaction device 102. As discussed above, the issuer server 110 may include one or more computing devices that are used to establish communication with another server (e.g., the payment network server 108) by exchanging messages with and/or passing information to the other server.

### The POP Hosts 150

The POP host 150 is a server associated with an entity (e.g., a company or organization) which manages (e.g., establishes, administers) the POP identity (with an associated proof of provenance identifier).

In one arrangement, the entity is a brand owner of the item. Therefore, each brand owner operates a POP host 150 to manage the proof of provenance identifier that the brand owner owns. In one arrangement, each brand owner issues a POP identity (with an associated POP identifier) using the POP host 150. In another arrangement, the entity is the entity operating the payment network server 108, such as Mastercard®.

The POP identity includes the item details (e.g., colour, description, size, etc.) and the current owner of the item. In one arrangement, the ownership of the item can be automatically updated (see FIG. 5 and the method 600).

### User Devices 142

The user device 142 is associated with a user accessing the proof of provenance server 140. The user device 142 may be a computing device, such as a desktop computer, an interactive voice response (IVR) system, a smartphone, a laptop computer, a personal digital assistant computer (PDA), a mobile computer, a tablet computer, and the like. The user device 142 may also be the transaction device 102 or the merchant device 104.

### A Method of Processing a Payment Transaction in Conjunction with a POP Transaction

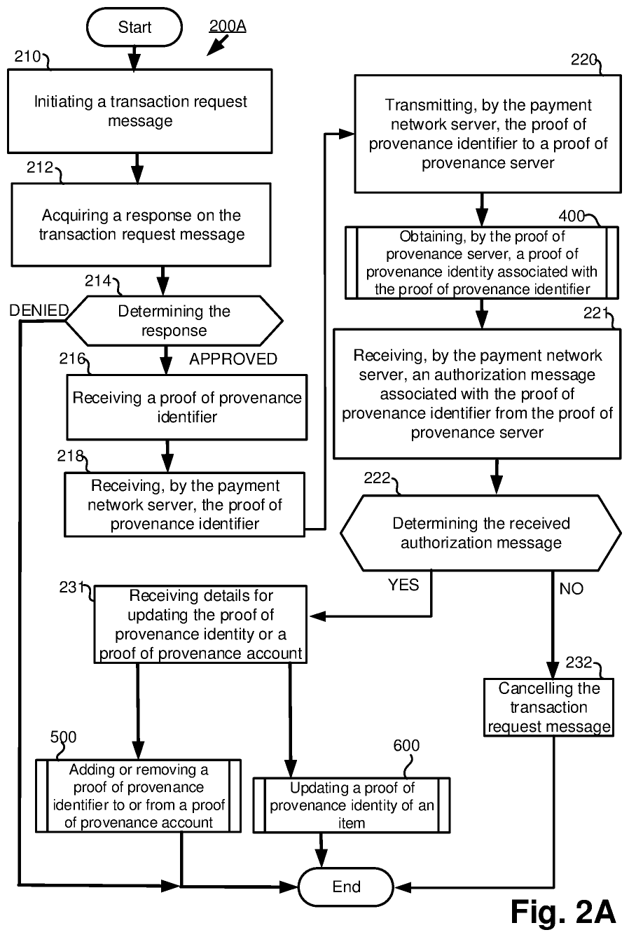

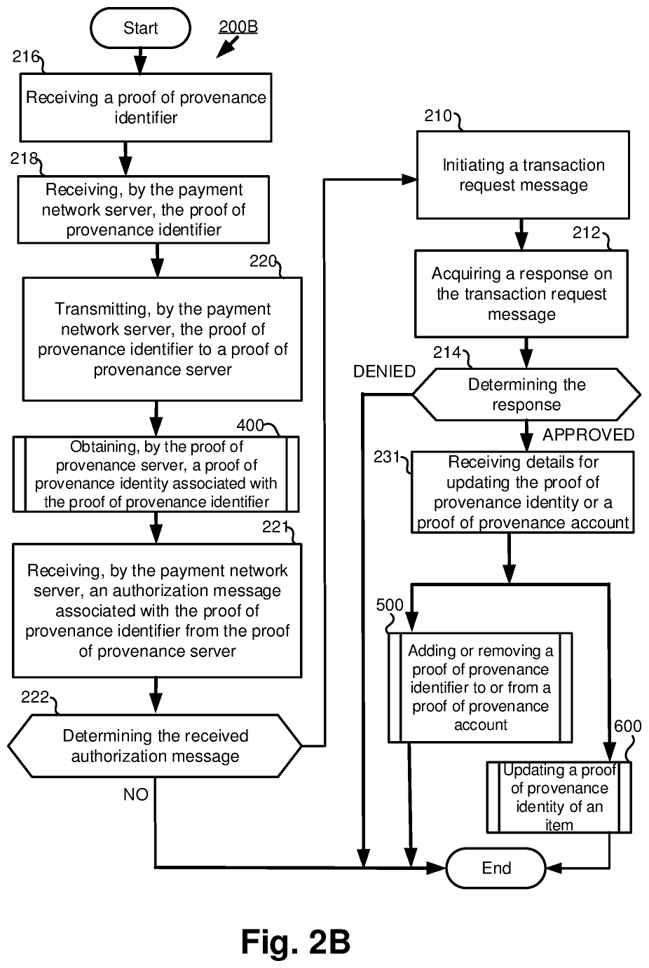

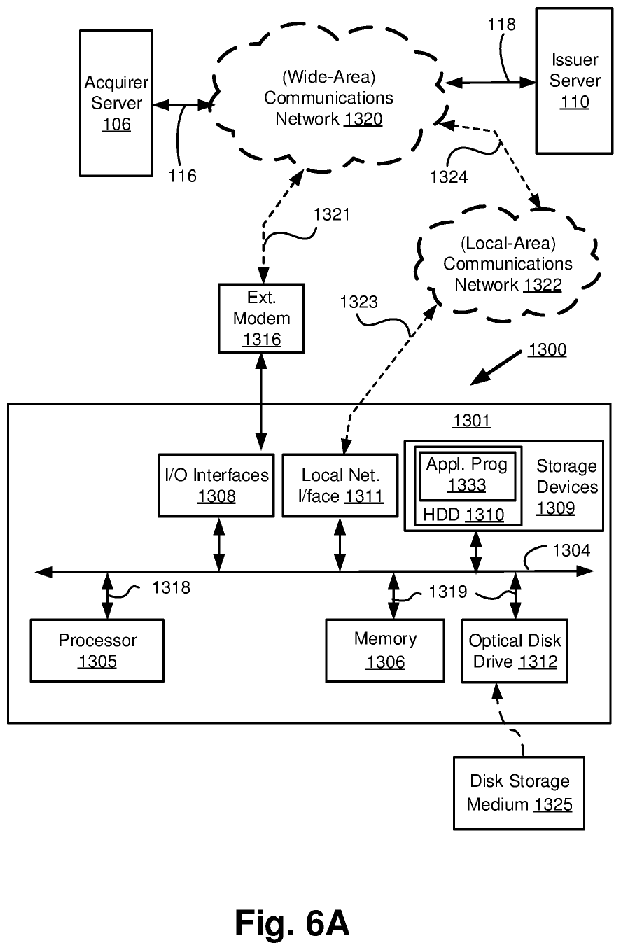

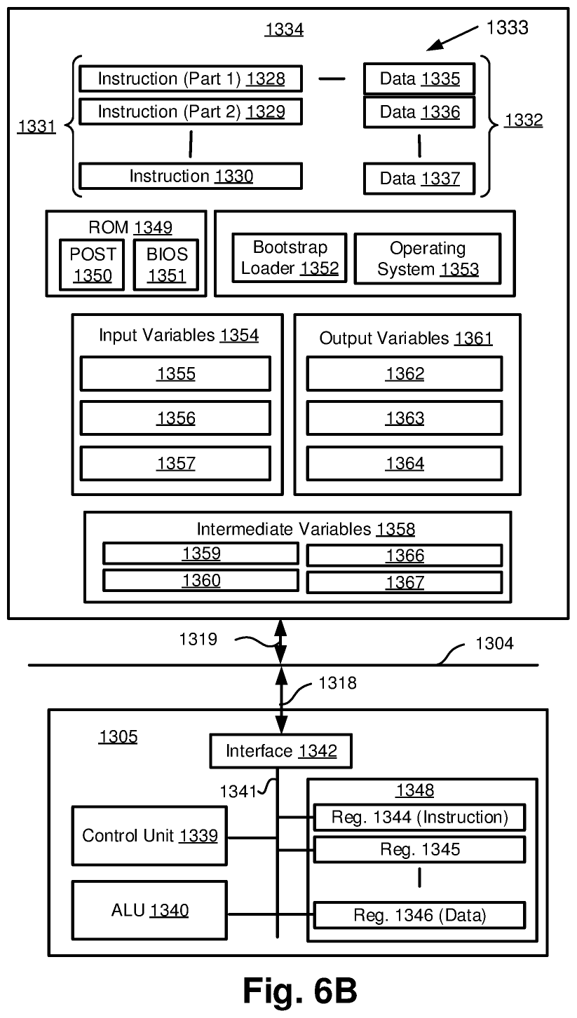

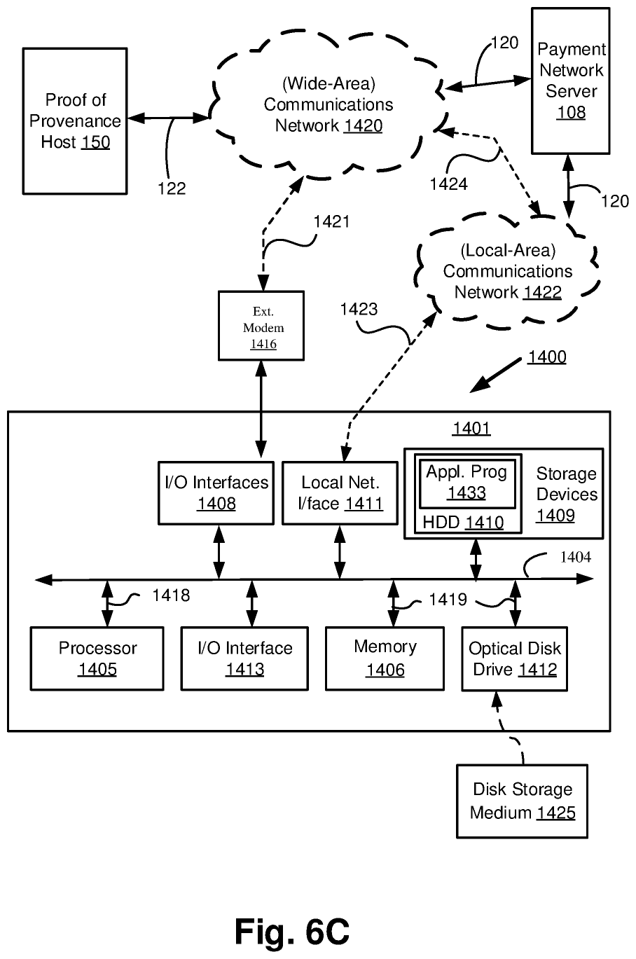

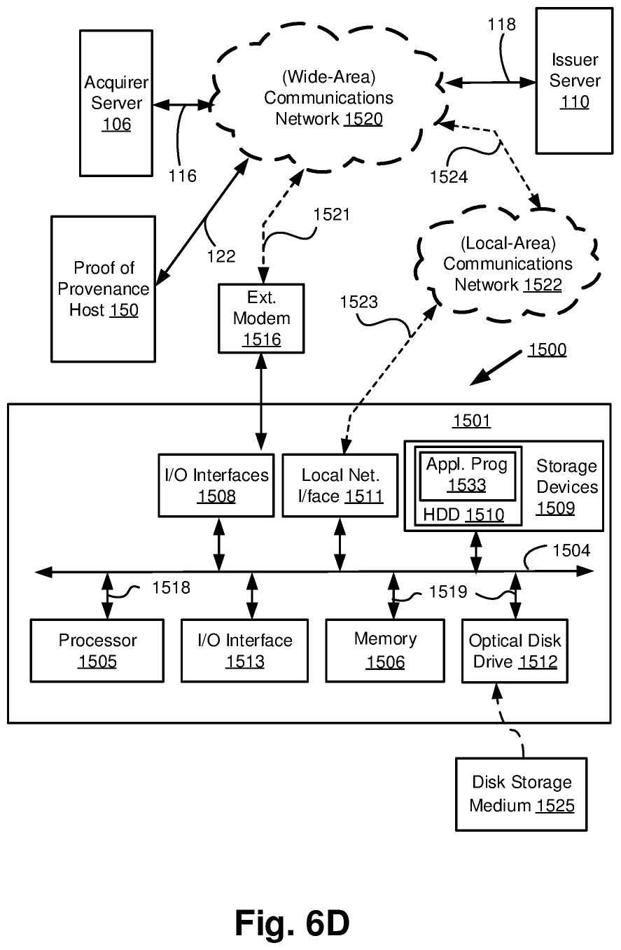

FIGS. 2A and 2B respectively show flow charts of methods 200A and 200B of processing a payment transaction and a POP transaction using the system 100. The methods 200A and 200B are implemented by software application programs that are executable by the devices 102, 104, 142, and the servers 106, 108, 110, 140, 150 in the system 100. The steps performed by the payment network server 108 in the methods 200A and 200B can be implemented by the software application programs 1333 executable within the computer system 1300 of the payment network server 108 (see FIG. 6A). In an alternative arrangement of a combined payment network server 108 and POP server 140 (as shown in FIG. 6D), the steps performed by the payment network server 108 in the methods 200A and 200B can be implemented by the software application programs 1533 executable within the computer system 1500.

The method 200A commences at step 210 (see FIG. 2A) by initiating a transaction request message associated with a payment transaction. When a customer wants to purchase an item from a merchant, the customer initiates a payment transaction. In one arrangement, the customer takes the item to a point-of-sale counter having a merchant device 104 where an employee of the merchant can scan the item at the merchant device 104. In another arrangement, the customer selects, on a web site of the merchant, the item that the customer would like to purchase. The item is then added into the transaction request message of the payment transaction.

The transaction request message is then displayed with the item to be purchased either at the merchant device 104 or the transaction device 102. The method 200A then proceeds from step 210 to step 212.

In step 212, a response to the transaction request message is acquired. The first step is for the transaction device 102 or the merchant device 104 to receive customer transaction credentials for the payment transaction. The customer transaction credentials can be received from the transaction device 102 and/or manually entered at the merchant device 104.

Once the transaction request message is displayed, the customer can then enter the customer transaction credentials (e.g., a payment account of the customer, a password of the payment account, etc.) at the merchant device 104 and/or the transaction device 102. Based on the received customer transaction credentials, the transaction request message includes a 16-digit EMV BIN that relates to the issuer of the customer's payment account.

The transaction request message also identifies a value or price of the item. The transaction request message may also indicate a time and date at which the payment transaction was initiated.

The merchant device 104 then transmits the transaction request message to an acquirer server. The acquirer server 106, in turn, transmits the transaction request message to the payment network server 108. In one arrangement, the acquirer server 106 merely receives the transaction request message from the merchant device 104 and forwards the transaction request message to the payment network server 108.

The payment network server 108 receives the transaction request message and processes the transaction request message. In this case, the payment network server 108 determines that the transaction request message includes a 16-digit EMV BIN that relates to an issuer and directs the transaction request message to the issuer server 110. The issuer server 110 in turn either authorizes or denies the transaction request message. For example, if there are no funds in the payment account of the customer, the issuer server 110 denies the transaction. On the other hand, if there is sufficient funds in the payment account of the customer, the issuer server 110 authorizes the transaction. The issuer server 110 then issues a transaction request response to the payment network server 108. In turn, the payment network server 108 transmits the transaction request response to the acquirer server 106 and the merchant device 104. The merchant device 104 then displays that the payment transaction is approved.

The method 200A then proceeds from step 212 to step 214.

In step 214, the merchant device 104 determines the response. If the response indicates approval (APPROVED), the method 200A proceeds from step 214 to step 216. Otherwise (DENIED), the method 200A concludes and the denial of the payment transaction is displayed on the merchant device 104.

In step 216, the merchant device 104 receives the POP identifier, which is in the transaction request message of step 210. The POP identifier can be read by or manually entered into the merchant device 104, as described above in relation to the discussion on the merchant device 104. Step 216 is the start of a POP transaction.

The merchant device 104 then transmits the POP identifier to the payment network server 108. When transmitting the POP identifier to the payment network server 108, the POP identifier is placed in a POP transaction message. The POP transaction message may be in accordance with ISO 8583 or ISO 20022 Standards. For example, the POP transaction message may have three parts. The first part relates to a POP transaction message type indicator (MTI) indicating the overall function of the message, the second part indicating functions to be performed by the POP server 140 in relation to the message, and the third part includes the POP identifier (and the PAR, if available). For the POP transaction described in steps 216 to 221, the second part of the POP transaction message indicates to the POP server 140 on the function to be performed (e.g., returning a response as to the existence of the POP identifier). In another arrangement, the POP transaction message may have a default function to return a response indicating the existence of the POP identifier, enabling the second part of the POP transaction message to be empty when the function relates to the default function.

The method 200A then proceeds from step 216 to step 218.

In step 218, the payment network server 108 receives the POP identifier. The method 200A proceeds from step 218 to step 220.

In step 220, the payment network server 108 transmits the POP identifier to the POP server 140. The method 200A then proceeds from step 220 to the method 400.

The method 400 is shown in FIG. 3. The method 400 is a method of obtaining the POP identity associated with a proof of provenance identity. The method 400 will be discussed in detail below. As will be described hereinafter, the method 400 returns the POP identity of a POP identifier. In one arrangement, item details (e.g., colour, description, size, etc.) and the ownership details (e.g., a name of an entity that owns the item, an address of the entity that owns the item) of the item may be returned. As would be understood, the POP identity that is obtained would be the POP identity as currently stored in the POP hosts 150 when the request to obtain the POP identity from a POP identifier is received. In another arrangement, the POP identity does not contain any details and the response received would be whether the proof of provenance identity exists at the appropriate POP host 150 (i.e., genuine).

As described in relation to step 216, the POP server 140 performs the function as indicated in the second part of the POP transaction message carrying the POP identifier. The second part may indicate to the POP server 140 on the response expected (e.g., item details, ownership details, existence of the POP identifier, etc.).

When the POP server 140 receives the request from the payment network server 108, the method 400 returns an authorization message indicating the existence of a POP identity of the POP identifier. No other detail is returned to the payment network server 108. If the POP identifier is not genuine (i.e., there is no corresponding POP identity), the POP server 140 returns an authorization message denying the POP transaction.

The method 200A then proceeds from the method 400 to step 221.

In step 221, the payment network server 108 receives the authorization message associated with the POP identity of the item from the proof of provenance server 140. The payment network server 108 in turn transmits the authorization message to the merchant device 104. The merchant device 104 then displays that the POP transaction is approved or denied. The denial reason may be stated on the merchant device 104. The method 200A then proceeds from step 221 to step 222.

In step 222, the merchant device 104 determines the authorization message received from the POP server 140.

If the authorization message is an approval (YES), then the method 200A proceeds from step 222 to step 231.

If the authorization message is a denial (NO), then the method 200A proceeds from step 222 to step 232.

In step 232, the payment transaction, which is approved at step 212, is cancelled. The merchant device 104 cancels the payment transaction by reversing the approved transaction request message. The merchant associated with the merchant device 104 may then take subsequent steps (e.g., removing the item, reporting that the item is a counterfeit item, etc.) when such a POP transaction is denied. The method 200A then concludes at the conclusion of step 232.

In step 231, details are received by the merchant device 104 to update the POP identity of the item in the approved payment and POP transactions above; and to update POP accounts of the respective merchant and customer. The details may be any one of a POP identifier, a POP account of the customer or merchant, customer transaction credentials, the name of the customer, and the like.

The merchant device 104 obtains the POP identifier as described above in relation to discussion on the merchant device 104.

The merchant device 104 obtains the customer transaction credentials, a POP account of the customer, a POP account of a registered user associated with the customer, the name of the customer, and the like, by requesting data to be manually entered. For ease of description hereinafter, a proof of provenance of a customer also refers to a proof of provenance of a registered user associated with a customer. In another arrangement, a customer may tap a payment card on the merchant device 104 for the merchant device 104 to obtain the customer transaction details and a POP account that may be linked to the payment card.

As described above in relation to step 216, the POP identifier is placed in a POP transaction message, which may be in accordance with ISO 8583 or ISO 20022 Standards. In the POP transaction message sent at step 231, the second part of the POP transaction message may include a request for the POP server 140 to update the POP identity relating to the POP identifier in the approved payment; and/or to update POP accounts of the respective merchant and customer. PAR associated with the transaction device 102 can be included in the POP transaction message to enable the POP server 140 to update the POP account associated with the PAR or to update the POP identity so as to be owned by the POP account associated with the PAR.

As described above in relation to the discussion on the merchant device 104, the merchant device 104 can also receive a POP account of a merchant.

In one arrangement, the merchant device 104 displays a follow-up request for the required details. A customer can then enter the details manually or by tapping a payment card.

The obtained details are then sent in a request to update the POP identity; and/or to update POP accounts of the respective merchant and customer. The request is sent to the POP server 140 via either the payment network server 108 or connection 123. If the obtained details relate to a payment card, then the payment network server 108 can be used to transmit the request. However, if the obtained details include POP accounts (and other details with higher data), then connection 123 is used to transmit the request.

The method 200A proceeds from step 231 to sub-process 500 and/or a method 600. Sub-process 500 is a method of adding the proof of provenance identifier in the approved transaction request message to the proof of provenance account of the customer. Sub-process 500 is also a method of removing the proof of provenance identifier in the approved transaction request message from the proof of provenance account of the merchant. The method 600 is a method of updating the ownership details of the proof of identifier of the item purchased in the approved transaction.

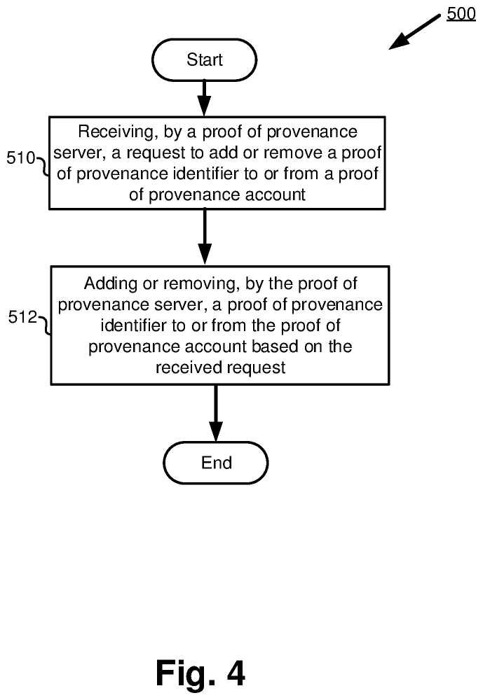

Both sub-process 500 and the method 600 will be described below in relation to FIGS. 4 and 5 respectively. The method 200A concludes at the conclusion of sub-process 500 and the method 600.

The method 200B is similar to the method 200A. In the method 200A, the payment transaction (steps 210 to 214) is performed before the POP transaction (steps 216 to 222). On the other hand, the method 200B performs the POP transaction (steps 216 to 222) before performing the payment transaction (steps 210 to 214).

The method 200B commences at step 216 where the merchant device 104 receives a POP identifier. The POP identifier can be read by or manually entered into the merchant device 104, as described above in relation to the discussion on the merchant device 104. Step 216 is as described in the method 200A. The method 200B then proceeds from step 216 to step 218.

In step 218, the payment network server 108 receives the POP identifier. The method 200B proceeds from step 218 to step 220.

In step 220, the payment network server 108 transmits the POP identifier to the POP server 140. The method 200B then proceeds from step 220 to the method 400.

As described above, when the POP server 140 receives the request from the payment network server 108, the method 400 returns an authorization message indicating the existence of a POP identity of the POP identifier. No other detail is returned to the payment network server 108. If the POP identifier is not genuine (i.e., there is no corresponding POP identity), the POP server 140 returns an authorization message indicating that there is no POP identity associated with the received POP identifier. The method 200B then proceeds from the method 400 to step 221.

In step 221, the payment network server 108 receives the authorization message associated with the POP identity of the item from the proof of provenance server 140. The method 200B then proceeds from step 221 to step 222.

In step 222, the payment network server 108 determines the authorization message received from the POP server 140. If the authorization message is an approval (YES), then the method 200B proceeds from step 222 to step 210. Otherwise, if the authorization message is a denial (NO), then the method 200B concludes.

In step 210, a transaction request message associated with a payment transaction is initiated. Step 210 is as described in the method 200A. The method 200B then proceeds from step 210 to step 212.

In step 212, a response to the transaction request message is acquired. Step 212 is as described above in the method 200A. The method 200B then proceeds from step 212 to step 214.

In step 214, the merchant device 104 determines the response. If the response indicates approval (APPROVED), the method 200B proceeds from step 214 to step 231. Otherwise (DENIED), the method 200B concludes.

In step 231, the merchant device 104 receives the details for updating the POP identity of the item in the approved payment and POP transactions above; and updating POP accounts of the respective merchant and customer. As described above in relation to step 231 of the method 200A, the request for updating of the POP identity and POP accounts can be embedded in the second part of the POP transaction message. The method 200B then proceeds from step 231 to sub-process 500 and/or the method 600.

### The Method 400 for Obtaining a POP Identity Associated with a POP Identifier

FIG. 3 shows a flow chart of the method 400 for obtaining a POP identity associated with a POP identifier. The steps in the method 400 can be implemented by the software application programs 1433 executable within the computer system 1400 of the proof of provenance server 140 (see FIG. 6C). In an alternative arrangement of a combined payment network server 108 and proof of provenance server 140 (as shown in FIG. 6D), the steps in the method 400 can be implemented by the software application programs 1533 executable within the computer system 1500.

The method 400 commences at step 410 where the POP server 140 receives a request to obtain a POP identity of a POP identifier. The request can be received from the payment network server 108 at the conclusion of step 220 of the methods 200A and 200B (discussed above), a transaction device 102, a merchant device 104, or any of the user devices 142.

As described in relation to step 216, the request may be embedded in the second part of the POP transaction message carrying the POP identifier.

The method 400 then proceeds from step 410 to step 411.

In step 411, the POP server 140 determines a POP host 150 associated with the received POP identifier. For example, the POP identifier may include a POP identifier associated with a brand owner or an entity hosting the POP host 150.

In one example, different brand owners own different POP hosts 150. Each brand owner can be identified with an identifier (e.g., a code, etc.) identifying the brand owner. For example, the last 5 numbers in the POP identifier can be used as an identifier of the brand owner.

The method 400 then proceeds from step 411 to step 412.

In step 412, the POP server 140 transmits the received POP identifier to a POP host 150 based on the determination in step 411. The POP host 150 then retrieves the details of the POP identifier and transmits the POP identity to the POP server 140. The method 400 then proceeds from step 412 to step 414.

In step 414, the POP server 140 receives the POP identity of the POP identifier from the POP host 150. The method 400 then proceeds from step 414 to step 416.

In step 416, the POP server 140 transmits the POP identity of the POP identifier to the requesting device (e.g., the transaction device 102, the merchant device 104, the user devices 142).

As described above in relation to step 221 of the methods 200A and 200B, the POP server 140 transmits an authorization message indicating the existence of a POP identity of the POP identifier. No other detail is returned to the payment network server 108. If the POP identifier is not genuine (i.e., there is no corresponding POP identity), the POP server 140 returns an authorization message indicating that there is no POP identity associated with the received POP identifier. The method 400 concludes at the conclusion of step 416.

### Sub-Process 500 for Updating a Proof of Provenance Account

FIG. 4 shows a flow chart of sub-process 500 for adding or removing a POP identity to or from a POP account. The steps in sub-process 500 can be implemented by the software application programs 1433 executable within the computer system 1400 of the POP server 140 (see FIG. 6C). In an alternative arrangement of a combined payment network server 108 and POP server 140 (as shown in FIG. 6D), the steps in sub-process 500 can be implemented by the software application programs 1533 executable within the computer system 1500.

Sub-process 500 commences at step 510 where the POP server 140 receives a request to add or remove a POP identity to or from a POP account. The request to do so can be received from the payment network server 108 at the completion of step 231 of the methods 200A and 200B. Such a request can also be received from the merchant device 104, via connection 123, at the completion of step 231. The request can also be triggered by the method 600. As described in relation to step 231, the request may be embedded in the second part of the POP transaction message carrying the POP identifier. PAR identifying the POP account to be updated can also be included in the POP transaction message as described above.

Sub-process 500 then proceeds from step 510 to step 512.

In step 512, the POP identifier received at step 510 is added to or removed from the POP accounts received at step 510. The POP identifier is added to the POP account of the customer, while the POP identifier is removed from the POP account of the merchant.

Sub-process 500 concludes at the conclusion of step 512.

### The Method 600 for Updating the Details of a POP Identity

FIG. 5 shows a flow chart of the method 600 for updating the details of a POP identifier at the POP host 150. The steps in the method 600 can be implemented by the software application programs 1433 executable within the computer system 1400 of the POP server 140 (see FIG. 6C). In an alternative arrangement of a combined payment network server 108 and POP server 140 (as shown in FIG. 6D), the steps in the method 600 can be implemented by the software application programs 1533 executable within the computer system 1500.

The method 600 commences at step 610 where the POP server 140 receives a request to update the ownership details of a POP identity at the POP host 150. The request to do so can be received from the payment network server 108 at the completion of step 231 of the methods 200A and 200B. Such a request can also be received from the merchant device 104, via connection 123, at the completion of step 231. The request can also be received from the current owner at any time from any of the user devices 142A to 142N. As described in relation to step 231, the request may be embedded in the second part of the POP transaction message carrying the POP identifier. PAR identifying the POP account that now owns the POP identifier can also be included in the POP transaction message as described above.

If the request is from the payment network server 108, the POP identifier relates to the item purchased in the approved transaction request message of the methods 200A and 200B. The ownership details can be updated based on a payment card detail received by the merchant device 104 at step 231. The payment card detail can be linked to a POP account of a user and, in this case, the ownership detail of the POP identity can be updated to include the POP account linked to the payment card.

If the request is from the current owner as listed in the POP identifier, the ownership details can be updated according to the name provided by the current owner.

The method 600 then proceeds from step 610 to step 612.

Step 612 is similar to step 411 where the POP server 140 determines a POP host 150 associated with the received POP identifier.

The method 600 then proceeds from step 612 to step 614.

In step 614, the POP server 140 transmits a request to the determined POP host 150 to update the ownership details of the POP identity.

The POP host 150 updates the ownership details of the POP identifier upon receiving such a request from the POP server 140.

In one arrangement, the method 600 also transmits a request to update the POP account of the user (which is linked to the payment card) so that the updated POP identifier is added to the POP account of the user. See sub-process 500 above for the process of updating a POP account.

In one arrangement, the method 600 also transmits a request to update the POP account of the merchant (which is removed from the POP identifier) so that the updated POP identifier is removed from the POP account of the merchant. See sub-process 500 above for the process of updating a POP account.

The method 600 concludes at the conclusion of step 614.

### USE CASE EXAMPLES

### Use Case 1

In the first use case, a customer is at a physical retail store and wants to buy an item that has a POP tag. The customer initiates a transaction by taking an item to a merchant device 104 (e.g., a POS terminal). The merchant scans the item using the merchant device 104, which reads the POP identifier. For the first use case, the merchant device 104 is a smart POS capable of receiving input (described below) from the user and communicating with the POP server 140 via connection 123. The merchant device 104 of the first use case may also be a server operating a website, from which the user input can be received.

The merchant device 104 then prompts the customer to enter the customer transaction credentials (e.g., a payment account, a password relating to the payment account) and a POP account of the customer. The customer can enter the payment account and the related password by scanning (or tapping) a transaction device 102 (e.g., a smart phone, a credit card) at the merchant device 104. In another arrangement, the customer can manually key in the password at the merchant device 104.

The POP account of the customer can be manually entered at the merchant device 104. Alternatively, the POP account can be determined by the POP server 140 from the payment account of the customer. As described above, the POP account of the customer refers to a POP account of the customer or a registered user associated with the customer. For example, the registered user could be a friend who the customer is buying the item for.

As described in the methods 200A and 200B, the merchant device 104 receives certain details in steps 210 and 216. In this particular arrangement, both steps are implemented at the start of the transaction rather than being implemented at different times of the transaction.

The merchant device 104 receives and generates the transaction request message (step 210) that includes the payment account and the password.

The merchant device 104 then transmits the transaction request message to the acquirer server 106. The acquirer server 106, in turn, transmits the transaction request message to the payment network server 108. When the payment network server 108 receives the transaction request message, the payment network server 108 forwards the transaction request message to the issuer server 110. The issuer server 110 provides a response indicating the approval or denial of the transaction request message (step 212).

The merchant device 104 receives the response and determines whether the response is an approval or denial. If the response is a denial, then the merchant device 104 displays that the payment transaction has been declined. If the response is an approval, the merchant device 104 continues with a POP transaction.

In this case, the merchant device 104 already obtained the details required for the POP transaction at the beginning of the process and therefore proceeds with the POP transaction without requesting further input from the user. The merchant device 104 transmits the POP identifier to the payment network server 108, which in turn transmits a request for an authorization message with the POP identifier to the POP server 140 (steps 218 and 220).

When the POP server 140 receives the request, the POP server 140 performs method 400 to determine whether the POP identifier in the request exists. If the POP identifier exists, the POP server 140 returns an authorization message indicating the existence of the POP identifier. The payment network server 108 receives the authorization message (step 221) and forwards the authorization message to the merchant device 104.

The merchant device 104 determines (step 222) whether the authorization message of the POP transaction is an approval or denial. If the authorization message is a denial, then the merchant device 104 initiates a process to reverse the approved transaction request message. The reversal process includes the merchant device 104 generating a request to reverse the transaction request message, transmitting the request to the acquirer server 106, the acquirer server 106 forwarding the request to the payment network server 108, the payment network server 108 transmitting the request to the issuer server 110, the issuer server 110 reversing the transaction request message based on the request, the issuer server 110 transmitting to the payment network server 108 a response indicating that the transaction request message has been reversed, the payment network server 108 transmitting the response to the acquirer server 106, and the acquirer server 106 transmitting the response to the merchant device 104.

If the authorization message is an approval, the merchant device 104 proceeds with updating the POP identity of the item and the respective POP accounts of the customer and merchant.

As described in the methods 200A and 200B, the merchant device 104 receives certain details in steps 210 and 231. In this particular arrangement, both steps are implemented at the start of the transaction rather than being implemented at different times of the transaction.

The merchant device 104 then transmits a request to update the POP identity of the item and the respective POP accounts. As discussed in step 231 above, such a request can be transmitted either via the payment network server 108 or the connection 123 depending on the data to be transmitted with the request. If the data involves payment accounts and a POP identifier then the payment network server 108 can be used. However, if the data involves POP accounts of the merchant and customer, then connection 123 is used as the payment network server 108 is restricted in terms of how much data is allowed to be transmitted through the payment network server 108.

The POP identity of the item is then updated to reflect that the customer is now the owner of the item. The POP account of the customer is also updated to include a POP identifier of the POP identity of the item. The POP account of the merchant is also updated to exclude the POP identifier of the POP identity of the item.

As would be understood, the POP transaction can occur before the payment transaction in the first use case in accordance with the method 200B. From the customer's point of view, the process does not change as user input is required at the beginning of the process.

### Use Case 2

In the second use case, a merchant device 104 is not a smart POS and is configured to receive customer transaction credentials and POP identifiers and forward the received details. The merchant device 104 has no storage capability to store received details. The merchant device 104 also has no connection 123 to the POP server 140.

Similar to the first use case, a customer is at a physical retail store and wants to buy an item that has a POP tag. The customer initiates a transaction by taking an item to a merchant device 104 (e.g., a POS terminal). The merchant scans the item using the merchant device 104, which reads the POP identifier. The merchant device 104 generates a transaction request message (step 210), which prompts the customer to enter the customer transaction credentials (e.g., a payment account, a password relating to the payment account). The customer can enter the payment account and the related password by scanning (or tapping) a transaction device 102 (e.g., a smart phone, a credit card) at the merchant device 104. In another arrangement, the customer can manually key in the password at the merchant device 104.

The merchant device 104 transmits the transaction request message that includes the payment account and the password to the acquirer server 106. The acquirer server 106, in turn, transmits the transaction request message to the payment network server 108. When the payment network server 108 receives the transaction request message, the payment network server 108 forwards the transaction request message to the issuer server 110. The issuer server 110 provides a response indicating the approval or denial of the transaction request message (step 212).

The merchant device 104 receives the response and determines whether the response is an approval or denial. If the response is a denial, then the merchant device 104 displays that the payment transaction has been declined. If the response is an approval, the merchant device 104 continues with a POP transaction.

In this case, the merchant device 104 prompts the user to scan the POP tag of the item. The merchant device 104 reads the POP identifier on the POP tag (step 216) and transmits the POP identifier to the payment network server 108. The payment network server 108 in turn transmits a request for an authorization message with the POP identifier to the POP server 140 (steps 218 and 220).

When the POP server 140 receives the request, the POP server 140 performs method 400 to determine whether the POP identifier in the request exists. If the POP identifier exists, the POP server 140 returns an authorization message indicating the existence of the POP identifier. The payment network server 108 receives the authorization message (step 221) and forwards the authorization message to the merchant device 104.

The merchant device 104 determines (step 222) whether the authorization message of the POP transaction is an approval or denial. If the authorization message is a denial, then the merchant device 104 initiates a process to reverse the approved transaction request message. If the authorization message is an approval, the merchant device 104 proceeds with updating the POP identity of the item and the respective POP accounts of the customer and merchant.

The merchant device 104 prompts the user to scan the POP tag of the item and to enter the customer transaction credentials. The merchant device 104 receives details of the POP identifier and the customer transaction credentials as described above.

The merchant device 104 then transmits a request to update the POP identity of the item. The request is transmitted via the payment network server 108. When the POP server 140 receives the request, the POP server 140 checks whether the customer transaction credentials (in particular, the payment account) relate to a POP account. The POP identity of the item is then updated to reflect that the linked POP account is now the owner of the item. The POP account of the customer is also updated to include a POP identifier of the POP identity of the item. The POP account of the merchant (identified from the POP identity during removal) is also updated to exclude the POP identifier of the POP identity of the item.

As would be understood, the POP transaction can occur before the payment transaction in the first use case in accordance with the method 200B.

### Structural Context

### The Payment Network Server 108

FIGS. 6A and 6B depict a general-purpose computer system 1300, upon which the payment network server 108 described can be practiced.

As seen in FIG. 6A, the computer system 1300 includes a computer module 1301. An external Modulator-Demodulator (Modem) transceiver device 1316 may be used by the computer module 1301 for communicating to and from a communications network 1320 via a connection 1321. The communications network 1320 may be a wide-area network (WAN), such as the Internet, a cellular telecommunications network, or a private WAN. Where the connection 1321 is a telephone line, the modem 1316 may be a traditional “dial-up” modem. Alternatively, where the connection 1321 is a high capacity (e.g., cable) connection, the modem 1316 may be a broadband modem. A wireless modem may also be used for wireless connection to the communications network 1320.

The computer module 1301 typically includes at least one processor unit 1305, and a memory unit 1306. For example, the memory unit 1306 may have semiconductor random access memory (RAM) and semiconductor read only memory (ROM). The computer module 1301 also includes an interface 1308 for the external modem 1316. In some implementations, the modem 1316 may be incorporated within the computer module 1301, for example, within the interface 1308. The computer module 1301 also has a local network interface 1311, which permits coupling of the computer system 1300 via a connection 1323 to a local-area communications network 1322, known as a Local Area Network (LAN). As illustrated in FIG. 6A, the local communications network 1322 may also couple to the wide network 1320 via a connection 1324, which would typically include a so-called “firewall” device or device of similar functionality. The local network interface 1311 may comprise an Ethernet circuit card, a Bluetooth® wireless arrangement or an IEEE 802.11 wireless arrangement. However, numerous other types of interfaces may be practiced for the interface 1311.

The I/O interfaces 1308 may afford either or both of serial and parallel connectivity, the former typically being implemented according to the Universal Serial Bus (USB) standards and having corresponding USB connectors (not illustrated). Storage devices 1309 are provided and typically include a hard disk drive (HDD) 1310. Other storage devices, such as a floppy disk drive and a magnetic tape drive (not illustrated), may also be used. An optical disk drive 1312 is typically provided to act as a non-volatile source of data. Portable memory devices, such as optical disks, USB-RAM, portable, external hard drives, and floppy disks, for example, may be used as appropriate sources of data to the system 1300.

The components 1305 to 1312 of the computer module 1301 typically communicate via an interconnected bus 1304 and in a manner that results in a conventional mode of operation of the computer system 1300 known to those in the relevant art. For example, the processor 1305 is coupled to the system bus 1304 using a connection 1318. Likewise, the memory 1306 and optical disk drive 1312 are coupled to the system bus 1304 by connections 1319. Examples of computers on which the described arrangements can be practised include IBM®-PC's and compatibles, Sun Sparcstations®, Apple®, or like computer systems.

The steps of the methods 200A and 200B in FIGS. 2A and 2B, respectively, performed by the payment network server 108 may be implemented using the computer system 1300. The steps of the methods 200A and 200B may be implemented as one or more software application programs 1333 executable within the computer system 1300. In particular, the steps of the methods 200A and 200B as performed by the payment network server 108 are effected by instructions 1331 (see FIG. 6B) in the software 1333 that are carried out within the computer system 1300. The software instructions 1331 may be formed as one or more code modules, each for performing one or more particular tasks. The software may also be divided into two separate parts, in which a first part and the corresponding code modules performs the steps of the payment network server 108 and a second part and the corresponding code modules manage a user interface between the first part and the user.

The software may be stored in a computer readable medium, including the storage devices described below, for example. The software is loaded into the computer system 1300 from the computer readable medium, and then executed by the computer system 1300. A computer readable medium having such software or computer program recorded on the computer readable medium is a computer program product. The use of the computer program product in the computer system 1300 preferably effects an advantageous apparatus for a payment network server 108.

The software 1333 is typically stored in the HDD 1310 or the memory 1306. The software is loaded into the computer system 1300 from a computer readable medium, and executed by the computer system 1300. Thus, for example, the software 1333 may be stored on an optically readable disk storage medium (e.g., CD-ROM) 1325 that is read by the optical disk drive 1312. A computer readable medium having such software or computer program recorded on it is a computer program product. The use of the computer program product in the computer system 1300 preferably effects an apparatus for a payment network server 108.

In some instances, the application programs 1333 may be supplied to the user encoded on one or more CD-ROMs 1325 and read via the corresponding drive 1312, or alternatively may be read by the user from the networks 1320 or 1322. Still further, the software can also be loaded into the computer system 1300 from other computer readable media. Computer readable storage media refers to any non-transitory tangible storage medium that provides recorded instructions and/or data to the computer system 1300 for execution and/or processing. Examples of such storage media include floppy disks, magnetic tape, optical disk, a hard disk drive, a ROM or integrated circuit, USB memory, a magneto-optical disk, or a computer readable card, such as a PCMCIA card and the like, whether or not such devices are internal or external of the computer module 1301. Examples of transitory or non-tangible computer readable transmission media that may also participate in the provision of software, application programs, instructions and/or data to the computer module 1301 include radio or infra-red transmission channels as well as a network connection to another computer or networked device, and the Internet or Intranets including e-mail transmissions and information recorded on Websites and the like.

The second part of the application programs 1333 and the corresponding code modules mentioned above may be executed to implement one or more graphical user interfaces (GUIs) to be rendered or otherwise represented upon a display. Through manipulation of typically a keyboard and a mouse, a user of the computer system 1300 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via loudspeakers and user voice commands input via a microphone.

FIG. 6B is a detailed schematic block diagram of the processor 1305 and a “memory” 1334. The memory 1334 represents a logical aggregation of all the memory modules (including the HDD 1309 and semiconductor memory 1306) that can be accessed by the computer module 1301 in FIG. 6A.

When the computer module 1301 is initially powered up, a power-on self-test (POST) program 1350 executes. The POST program 1350 is typically stored in a ROM 1349 of the semiconductor memory 1306 of FIG. 13A. A hardware device, such as the ROM 1349 storing software, is sometimes referred to as firmware. The POST program 1350 examines hardware within the computer module 1301 to ensure proper functioning and typically checks the processor 1305, the memory 1334 (1309, 1306), and a basic input-output systems software (BIOS) module 1351, also typically stored in the ROM 1349, for correct operation. Once the POST program 1350 has run successfully, the BIOS 1351 activates the hard disk drive 1310 of FIG. 6A. Activation of the hard disk drive 1310 causes a bootstrap loader program 1352 that is resident on the hard disk drive 1310 to execute via the processor 1305. This loads an operating system 1353 into the RAM memory 1306, upon which the operating system 1353 commences operation. The operating system 1353 is a system level application, executable by the processor 1305, to fulfil various high level functions, including processor management, memory management, device management, storage management, software application interface, and generic user interface.

The operating system 1353 manages the memory 1334 (1309, 1306) to ensure that each process or application running on the computer module 1301 has sufficient memory in which to execute without colliding with memory allocated to another process. Furthermore, the different types of memory available in the system 1300 of FIG. 6A must be used properly so that each process can run effectively. Accordingly, the aggregated memory 1334 is not intended to illustrate how particular segments of memory are allocated (unless otherwise stated), but rather to provide a general view of the memory accessible by the computer system 1300 and how such is used.

As shown in FIG. 6B, the processor 1305 includes a number of functional modules including a control unit 1339, an arithmetic logic unit (ALU) 1340, and a local or internal memory 1348, sometimes called a cache memory. The cache memory 1348 typically includes a number of storage registers 1344-1346 in a register section. One or more internal busses 1341 functionally interconnect these functional modules. The processor 1305 typically also has one or more interfaces 1342 for communicating with external devices via the system bus 1304, using a connection 1318. The memory 1334 is coupled to the bus 1304 using a connection 1319.

The application program 1333 includes a sequence of instructions 1331 that may include conditional branch and loop instructions. The program 1333 may also include data 1332 which is used in execution of the program 1333. The instructions 1331 and the data 1332 are stored in memory locations 1328, 1329, 1330 and 1335, 1336, 1337, respectively. Depending upon the relative size of the instructions 1331 and the memory locations 1328-1330, a particular instruction may be stored in a single memory location as depicted by the instruction shown in the memory location 1330. Alternately, an instruction may be segmented into a number of parts each of which is stored in a separate memory location, as depicted by the instruction segments shown in the memory locations 1328 and 1329.

In general, the processor 1305 is given a set of instructions which are executed therein. The processor 1305 waits for a subsequent input, to which the processor 1305 reacts to by executing another set of instructions. Each input may be provided from one or more of a number of sources, including data generated by one or more of the input devices (not shown) data received from an external source across one of the networks 1320, 1322, data retrieved from one of the storage devices 1306, 1309 or data retrieved from a storage medium 1325 inserted into the corresponding reader 1312, all depicted in FIG. 6A. The execution of a set of the instructions may in some cases result in output of data. Execution may also involve storing data or variables to the memory 1334.

The disclosed payment network server 108 arrangements use input variables 1354, which are stored in the memory 1334 in corresponding memory locations 1355, 1356, 1357. The payment network server 108 arrangements produce output variables 1361, which are stored in the memory 1334 in corresponding memory locations 1362, 1363, 1364. Intermediate variables 1358 may be stored in memory locations 1359, 1360, 1366 and 1367.

Referring to the processor 1305 of FIG. 6B, the registers 1344, 1345, 1346, the arithmetic logic unit (ALU) 1340, and the control unit 1339 work together to perform sequences of micro-operations needed to perform “fetch, decode, and execute” cycles for every instruction in the instruction set making up the program 1333. Each fetch, decode, and execute cycle comprises: a fetch operation, which fetches or reads an instruction 1331 from a memory location 1328, 1329, 1330; a decode operation in which the control unit 1339 determines which instruction has been fetched; and an execute operation in which the control unit 1339 and/or the ALU 1340 executes the instruction.

Thereafter, a further fetch, decode, and execute cycle for the next instruction may be executed. Similarly, a store cycle may be performed by which the control unit 1339 stores or writes a value to a memory location 1332.

Each step or sub-process in the processes of FIGS. 2A and 2B, as performed by the payment network server 108, is associated with one or more segments of the program 1333 and is performed by the register section 1344, 1345, 1346, the ALU 1340, and the control unit 1339 in the processor 1305 working together to perform the fetch, decode, and execute cycles for every instruction in the instruction set for the noted segments of the program 1333.

It is to be understood that the structural context of the computer system 1300 (i.e., the payment network server 108) is presented merely by way of example. Therefore, in some arrangements, one or more features of the server 1300 may be omitted. Also, in some arrangements, one or more features of the server 1300 may be combined together. Additionally, in some arrangements, one or more features of the server 1300 may be split into one or more component parts.

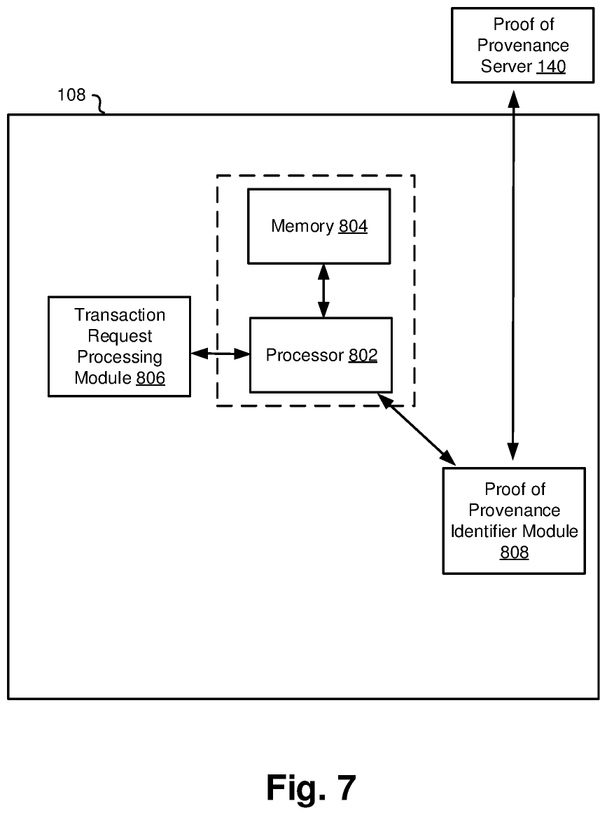

FIG. 7 shows an alternative implementation of the payment network server 108 (i.e., the computer system 1300). In the alternative implementation, the payment network server 108 may be generally described as a physical device comprising at least one processor 802 and at least one memory 804 including computer program codes. The at least one memory 804 and the computer program codes are configured to, with the at least one processor 802, cause the payment network server 108 to perform the operations described in the methods 200A and 200B. The payment network server 108 may also include a transaction request processing module 806 and a proof of provenance identifier module 808. The memory 804 stores computer program code that the processor 802 compiles to have each of the modules 806 and 808 perform their respective functions.

With reference to FIGS. 1, 2A, and 2B, the transaction request processing module 806 performs the function of communicating with the acquirer server 106 and the issuer server 110 to respectively receive and transmit a transaction request message.

With reference to FIGS. 1, 2A, and 2B, the proof of provenance identifier module 808 performs the function of communicating with the proof of provenance server 140 to transmit a POP identifier to the POP server 140 and receive an authorization message indicating the approval (e.g., existence) or denial (e.g., non-existence) of the POP identifier.

### The Proof of Provenance Server 140

FIG. 6C depicts a general-purpose computer system 1400, upon which the proof of provenance server 140 described can be practiced. The computer system 1400 includes a computer module 1401. An external Modulator-Demodulator (Modem) transceiver device 1416 may be used by the computer module 1401 for communicating to and from a communications network 1420 via a connection 1421. The communications network 1420 may be a wide-area network (WAN), such as the Internet, a cellular telecommunications network, or a private WAN. Where the connection 1421 is a telephone line, the modem 1416 may be a traditional “dial-up” modem. Alternatively, where the connection 1421 is a high capacity (e.g., cable) connection, the modem 1416 may be a broadband modem. A wireless modem may also be used for wireless connection to the communications network 1420.

The computer module 1401 typically includes at least one processor unit 1405, and a memory unit 1406. For example, the memory unit 1406 may have semiconductor random access memory (RAM) and semiconductor read only memory (ROM). The computer module 1401 also includes an interface 1408 for the external modem 1416. In some implementations, the modem 1416 may be incorporated within the computer module 1401, for example, within the interface 1408. The computer module 1401 may also include additional I/O interface 1413, which has similar functions as the I/O Interfaces 1408. The computer module 1401 also has a local network interface 1411, which permits coupling of the computer system 1400 via a connection 1423 to a local-area communications network 1422, known as a Local Area Network (LAN). As illustrated in FIG. 6C, the local communications network 1422 may also couple to the wide network 1420 via a connection 1424, which would typically include a so-called “firewall” device or device of similar functionality. The local network interface 1411 may comprise an Ethernet circuit card, a Bluetooth® wireless arrangement or an IEEE 802.11 wireless arrangement. However, numerous other types of interfaces may be practiced for the interface 1411.

The I/O interfaces 1408 may afford either or both of serial and parallel connectivity, the former typically being implemented according to the Universal Serial Bus (USB) standards and having corresponding USB connectors (not illustrated). Storage devices 1409 are provided and typically include a hard disk drive (HDD) 1410. Other storage devices, such as a floppy disk drive and a magnetic tape drive (not illustrated), may also be used. An optical disk drive 1412 is typically provided to act as a non-volatile source of data. Portable memory devices, such as optical disks, USB-RAM, portable, external hard drives, and floppy disks, for example, may be used as appropriate sources of data to the system 1400.

The components 1405 to 1412 of the computer module 1401 typically communicate via an interconnected bus 1404 and in a manner that results in a conventional mode of operation of the computer system 1400 known to those in the relevant art. For example, the processor 1405 is coupled to the system bus 1404 using a connection 1418. Likewise, the memory 1406 and optical disk drive 1412 are coupled to the system bus 1404 by connections 1419. Examples of computers on which the described arrangements can be practised include IBM®-PC's and compatibles, Sun Sparcstations®, Apple®, or like computer systems.

The sub-processes 400, 500, and 600 in FIGS. 3 to 5, respectively, performed by the proof of provenance server 140 may be implemented using the computer system 1400. The sub-processes 400, 500, and 600 may be implemented as one or more software application programs 1433 executable within the computer system 1400. In particular, the sub-processes 400, 500, and 600 are effected by instructions (see corresponding component 1331 in FIG. 6B) in the software 1433 that are carried out within the computer system 1400. The software instructions may be formed as one or more code modules, each for performing one or more particular tasks. The software may also be divided into two separate parts, in which a first part and the corresponding code modules performs the sub-processes 400, 500, and 600 and a second part and the corresponding code modules manage a user interface between the first part and the user.

The software may be stored in a computer readable medium, including the storage devices described below, for example. The software is loaded into the computer system 1400 from the computer readable medium, and then executed by the computer system 1400. A computer readable medium having such software or computer program recorded on the computer readable medium is a computer program product. The use of the computer program product in the computer system 1400 preferably effects an advantageous apparatus for a proof of provenance server 140.

The software 1433 is typically stored in the HDD 1410 or the memory 1406. The software is loaded into the computer system 1400 from a computer readable medium, and executed by the computer system 1400. Thus, for example, the software 1433 may be stored on an optically readable disk storage medium (e.g., CD-ROM) 1425 that is read by the optical disk drive 1412. A computer readable medium having such software or computer program recorded on it is a computer program product. The use of the computer program product in the computer system 1400 preferably effects an apparatus for a proof of provenance server 140.

In some instances, the application programs 1433 may be supplied to the user encoded on one or more CD-ROMs 1425 and read via the corresponding drive 1412, or alternatively may be read by the user from the networks 1420 or 1422. Still further, the software can also be loaded into the computer system 1400 from other computer readable media. Computer readable storage media refers to any non-transitory tangible storage medium that provides recorded instructions and/or data to the computer system 1400 for execution and/or processing. Examples of such storage media include floppy disks, magnetic tape, optical disc, a hard disk drive, a ROM or integrated circuit, USB memory, a magneto-optical disk, or a computer readable card, such as a PCMCIA card and the like, whether or not such devices are internal or external of the computer module 1401. Examples of transitory or non-tangible computer readable transmission media that may also participate in the provision of software, application programs, instructions and/or data to the computer module 1401 include radio or infra-red transmission channels as well as a network connection to another computer or networked device, and the Internet or Intranets including e-mail transmissions and information recorded on Websites, and the like.

The second part of the application programs 1433 and the corresponding code modules mentioned above may be executed to implement one or more graphical user interfaces (GUIs) to be rendered or otherwise represented upon a display. Through manipulation of typically a keyboard and a mouse, a user of the computer system 1400 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via loudspeakers and user voice commands input via a microphone.

It is to be understood that the structural context of the computer system 1400 (i.e., the proof of provenance server 140) is presented merely by way of example. Therefore, in some arrangements, one or more features of the server 1400 may be omitted. Also, in some arrangements, one or more features of the server 1400 may be combined together. Additionally, in some arrangements, one or more features of the server 1400 may be split into one or more component parts.

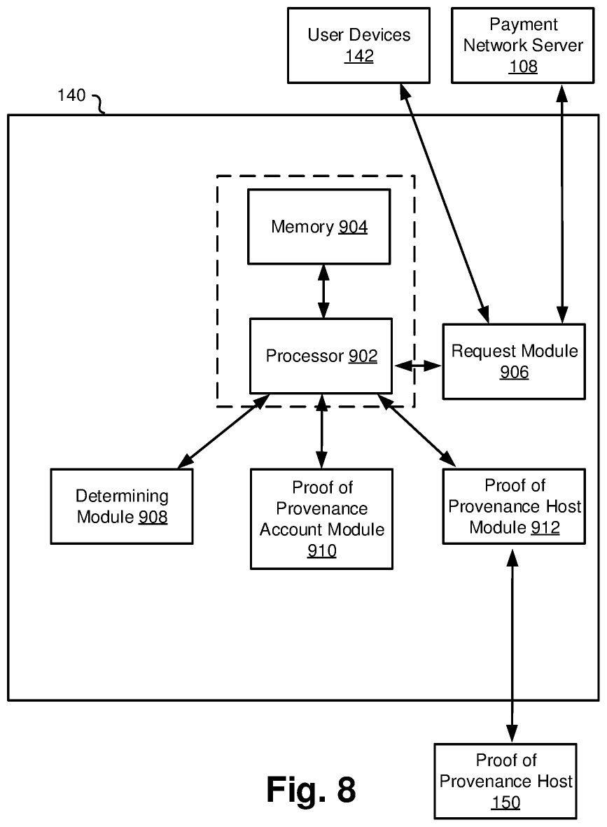

FIG. 8 shows an alternative implementation of the proof of provenance server 140 (i.e., the computer system 1400). In the alternative implementation, the proof of provenance server 140 may be generally described as a physical device comprising at least one processor 902 and at least one memory 904 including computer program codes. The at least one memory 904 and the computer program codes are configured to, with the at least one processor 902, cause the proof of provenance server 140 to perform the operations described in the sub-processes 400, 500, and 600. The proof of provenance server 140 may also include a request module 906, a determining module 908, a proof of provenance account module 910, and a proof of provenance host module 912. The memory 904 stores computer program code that the processor 902 compiles to have each of the modules 906 to 912 perform their respective functions.

With reference to FIGS. 1 and 3 to 5, the request module 906 performs the function of communicating with the payment network server 108 and the user devices 142 to receive requests, such as requests to obtain a POP identity of a POP identifier.

With reference to FIGS. 1 and 3 to 5, the determining module 908 performs the function of determining, from a received POP identifier, the relevant POP host 150 to communicate with to obtain the POP identity of the POP identifier.

With reference to FIGS. 1 and 3 to 5, the POP account module 910 performs the function of managing (e.g., establishing, updating, etc.) the POP accounts of users.

With reference to FIGS. 1 and 3 to 5, the POP host module 912 performs the function of communicating with the POP host 150.

### The Combined Payment Network Server 108 and Proof of Provenance Server 140

FIG. 6D depicts a general-purpose computer system 1500, upon which a combined payment network server 108 and proof of provenance server 140 described can be practiced. The computer system 1500 includes a computer module 1501. An external Modulator-Demodulator (Modem) transceiver device 1516 may be used by the computer module 1501 for communicating to and from a communications network 1520 via a connection 1521. The communications network 1520 may be a wide-area network (WAN), such as the Internet, a cellular telecommunications network, or a private WAN. Where the connection 1521 is a telephone line, the modem 1516 may be a traditional “dial-up” modem. Alternatively, where the connection 1521 is a high capacity (e.g., cable) connection, the modem 1516 may be a broadband modem. A wireless modem may also be used for wireless connection to the communications network 1520.

The computer module 1501 typically includes at least one processor unit 1505, and a memory unit 1506. For example, the memory unit 1506 may have semiconductor random access memory (RAM) and semiconductor read only memory (ROM). The computer module 1501 also includes an interface 1508 for the external modem 1516. In some implementations, the modem 1516 may be incorporated within the computer module 1501, for example within the interface 1508. The computer module 1501 may also include additional I/O interface 1513, which has similar functions as the I/O Interfaces 1508. The computer module 1501 also has a local network interface 1511, which permits coupling of the computer system 1500 via a connection 1523 to a local-area communications network 1522, known as a Local Area Network (LAN). As illustrated in FIG. 6D, the local communications network 1522 may also couple to the wide network 1520 via a connection 1524, which would typically include a so-called “firewall” device or device of similar functionality. The local network interface 1511 may comprise an Ethernet circuit card, a Bluetooth® wireless arrangement or an IEEE 802.11 wireless arrangement; however, numerous other types of interfaces may be practiced for the interface 1511.

The I/O interfaces 1508 may afford either or both of serial and parallel connectivity, the former typically being implemented according to the Universal Serial Bus (USB) standards and having corresponding USB connectors (not illustrated). Storage devices 1509 are provided and typically include a hard disk drive (HDD) 1510. Other storage devices such as a floppy disk drive and a magnetic tape drive (not illustrated) may also be used. An optical disk drive 1512 is typically provided to act as a non-volatile source of data. Portable memory devices, such optical disks, USB-RAM, portable, external hard drives, and floppy disks, for example, may be used as appropriate sources of data to the system 1500.

The components 1505 to 1512 of the computer module 1501 typically communicate via an interconnected bus 1504 and in a manner that results in a conventional mode of operation of the computer system 1500 known to those in the relevant art. For example, the processor 1505 is coupled to the system bus 1504 using a connection 1518. Likewise, the memory 1506 and optical disk drive 1512 are coupled to the system bus 1504 by connections 1519. Examples of computers on which the described arrangements can be practised include IBM®-PC's and compatibles, Sun Sparcstations®, Apple®, or like computer systems.

The steps of the methods 200A and 200B in FIGS. 2A and 2B, respectively, performed by the payment network server 108; and sub-processes 400, 500, and 600 in FIGS. 3 to 5, respectively, performed by the proof of provenance server 140 may be implemented using the computer system 1500. The steps of the methods 200A and 200B as performed by the payment network server 108 and sub-processes 400, 500, and 600 may be implemented as one or more software application programs 1533 executable within the computer system 1500. In particular, the steps of the methods 200A, 200B and sub-processes 400, 500, and 600 are effected by instructions (see corresponding component 1331 in FIG. 6B) in the software 1533 that are carried out within the computer system 1500. The software instructions may be formed as one or more code modules, each for performing one or more particular tasks. The software may also be divided into two separate parts, in which a first part and the corresponding code modules performs the steps of the methods 200A, 200B and sub-processes 400, 500, and 600 and a second part and the corresponding code modules manage a user interface between the first part and the user.

The software may be stored in a computer readable medium, including the storage devices described below, for example. The software is loaded into the computer system 1500 from the computer readable medium, and then executed by the computer system 1500. A computer readable medium having such software or computer program recorded on the computer readable medium is a computer program product. The use of the computer program product in the computer system 1500 preferably effects an advantageous apparatus for a combined payment network server 108 and proof of provenance server 140.

The software 1533 is typically stored in the HDD 1510 or the memory 1506. The software is loaded into the computer system 1500 from a computer readable medium, and executed by the computer system 1500. Thus, for example, the software 1533 may be stored on an optically readable disk storage medium (e.g., CD-ROM) 1525 that is read by the optical disk drive 1512. A computer readable medium having such software or computer program recorded on it is a computer program product. The use of the computer program product in the computer system 1500 preferably effects an apparatus for a combined payment network server 108 and proof of provenance server 140.

In some instances, the application programs 1533 may be supplied to the user encoded on one or more CD-ROMs 1525 and read via the corresponding drive 1512, or alternatively may be read by the user from the networks 1520 or 1522. Still further, the software can also be loaded into the computer system 1500 from other computer readable media. Computer readable storage media refers to any non-transitory tangible storage medium that provides recorded instructions and/or data to the computer system 1500 for execution and/or processing. Examples of such storage media include floppy disks, magnetic tape, optical disc, a hard disk drive, a ROM or integrated circuit, USB memory, a magneto-optical disk, or a computer readable card, such as a PCMCIA card and the like, whether or not such devices are internal or external of the computer module 1501. Examples of transitory or non-tangible computer readable transmission media that may also participate in the provision of software, application programs, instructions and/or data to the computer module 1501 include radio or infra-red transmission channels as well as a network connection to another computer or networked device, and the Internet or Intranets including e-mail transmissions and information recorded on Websites, and the like.

The second part of the application programs 1533 and the corresponding code modules mentioned above may be executed to implement one or more graphical user interfaces (GUIs) to be rendered or otherwise represented upon a display. Through manipulation of typically a keyboard and a mouse, a user of the computer system 1500 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via loudspeakers and user voice commands input via a microphone.

It is to be understood that the structural context of the computer system 1500 (i.e., the proof of provenance host 150) is presented merely by way of example. Therefore, in some arrangements, one or more features of the computer system 1500 may be omitted. Also, in some arrangements, one or more features of the computer system 1500 may be combined together. Additionally, in some arrangements, one or more features of the computer system 1500 may be split into one or more component parts.

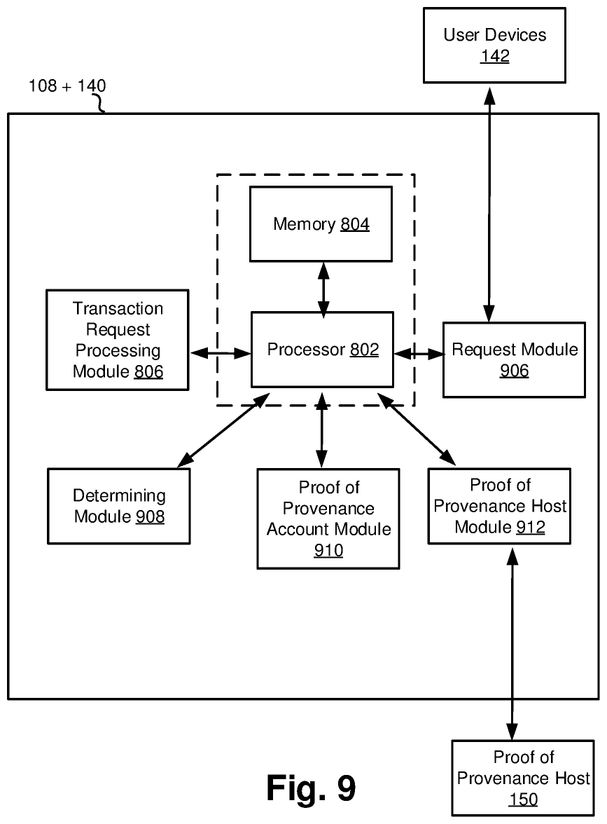

FIG. 9 shows an alternative implementation of the combined payment network server 108 and proof of provenance server 140 (i.e., the computer system 1500). In the alternative implementation, the combined payment network server 108 and proof of provenance server 140 may be generally described as a physical device comprising at least one processor 1002 and at least one memory 904 including computer program codes. The at least one memory 1004 and the computer program codes are configured to, with the at least one processor 1002, cause the combined payment network server 108 and proof of provenance server 140 to perform the operations described in the steps of the methods 200A, 200B and sub-processes 400, 500, and 600. The combined payment network server 108 and proof of provenance server 140 may also include a transaction request processing module 806, a proof of provenance identifier module 808, a request module 906, a determining module 908, a proof of provenance account module 910, and a proof of provenance host module 912. The memory 1004 stores computer program code that the processor 1002 compiles to have each of the modules 806 to 912 performs their respective functions.

With reference to FIGS. 1, 2A, and 2B, the transaction request processing module 806 performs the function of communicating with the acquirer server 106 and the issuer server 110 to respectively receive and transmit a transaction request message.

With reference to FIGS. 1 and 3 to 5, the request module 906 performs the function of communicating with the user devices 142 to receive requests, such as requests to obtain details of proof of provenance identities.

With reference to FIGS. 1 and 3 to 5, the determining module 908 performs the function of determining, from a received proof of provenance identifier, the relevant proof of provenance host 150 to communicate with to obtain the details of the proof of provenance identifier.

With reference to FIGS. 1 and 3 to 5, the proof of provenance account module 910 performs the function of managing (e.g., establishing, updating, etc.) the proof of provenance accounts of users.

With reference to FIGS. 1 and 3 to 5, the proof of provenance host module 912 performs the function of communicating with the proof of provenance host 150.

### INDUSTRIAL APPLICABILITY

The arrangements described are applicable to the computer and data processing industries and particularly for the financial transaction and goods authentication industries.

The foregoing describes only some embodiments of the present disclosure, and modifications and/or changes can be made thereto without departing from the scope and spirit of the disclosure, the embodiments being illustrative and not restrictive.

With that said, and as described, it should be appreciated that one or more aspects of the present disclosure transform a general-purpose computing device into a special-purpose computing device (or computer) when configured to perform the functions, methods, and/or processes described herein. In connection therewith, in various embodiments, computer-executable instructions (or code) may be stored in memory of such computing device for execution by a processor to cause the processor to perform one or more of the functions, methods, and/or processes described herein, such that the memory is a physical, tangible, and non-transitory computer readable storage media. Such instructions often improve the efficiencies and/or performance of the processor that is performing one or more of the various operations herein. It should be appreciated that the memory may include a variety of different memories, each implemented in one or more of the operations or processes described herein. What's more, a computing device as used herein may include a single computing device or multiple computing devices.

In addition, and as described, the terminology used herein is for the purpose of describing particular exemplary embodiments only and is not intended to be limiting. As used herein, the singular forms “a,” “an,” and “the” may be intended to include the plural forms as well, unless the context clearly indicates otherwise. And, again, the terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and the term “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

It is also noted that none of the elements recited in the claims herein are intended to be a means-plus-function element within the meaning of 35 U.S.C. § 112(f) unless an element is expressly recited using the phrase “means for,” or in the case of a method claim using the phrases “operation for” or “step for.”

Again, the foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A payment network server for processing a proof of provenance transaction, the payment network server comprising:
a processor;
a memory in communication with the processor, the memory comprising computer application programs that are executable by the processor, wherein, when the computer application programs are executed by the processor, the processor is configured to:
receive a proof of provenance identifier;
transmit the proof of provenance identifier to a proof of provenance server; and
receive an authorization message indicating an approval or denial of the proof of provenance identifier.

2. The payment network server of claim 1, wherein the processor is further configured to process a payment transaction, and wherein when the computer application programs are executed by the processor in connection with processing the payment transaction, the processor is configured to:
receive a transaction request message associated with the proof of provenance identifier;
forward the transaction request message to an issuer server; and
receive a response indicating an approval or denial of the transaction request message.

3. The payment network server of claim 2, wherein the processor is further configured to:
receive the proof of provenance identifier and payment account details for updating a proof of provenance identity associated with the received proof of provenance identifier; and
transmit the received proof of provenance identifier and the payment account details to the proof of provenance server.

4. The payment network server of claim 2, wherein the processor is further configured to:
receive a request to reverse the approved transaction request message; and
transmit the request to the issuer server.

5. The payment network server of claim 1, wherein the payment network server is combined with the proof of provenance server.

6. The payment network server of claim 5, wherein the processer is further configured to:
receive a request to obtain the proof of provenance identity of the proof of provenance identifier from the payment network server;
determine a proof of provenance host associated with the received proof of provenance identifier;
transmit the received proof of provenance identifier to the determined proof of provenance host;
receive the proof of provenance identity associated with the transmitted proof of provenance identifier from the determined proof of provenance host; and
transmit the authorization message indicating the approval of the proof of provenance identifier based on the received proof of provenance identity to the payment network server.

7. The payment network server of claim 5, wherein the processor is further configured to:
receive a request to obtain the proof of provenance identity of the proof of provenance identifier from a computing device;
determine a proof of provenance host associated with the received proof of provenance identifier;
transmit the received proof of provenance identifier to the determined proof of provenance host;
receive the proof of provenance identity associated with the transmitted proof of provenance identifier from the determined proof of provenance host; and
transmit the received proof of provenance identity to the computing device.

8. The payment network server of claim 5, wherein the processor is further configured to:
receive a request to update the proof of provenance identity, the request comprising the proof of provenance identifier and the payment account details;
determine a proof of provenance host associated with the received proof of provenance identifier; and
transmit the received request to the determined proof of provenance host.

9. The payment network server of claim 5, wherein the processor is further configured to:
receive a request to update a proof of provenance account of a user, the request comprising the proof of provenance identifier; and
update the proof of provenance account based on the proof of provenance identifier.

10. A computer-implemented method of processing a proof of provenance transaction, comprising:
receiving, by a payment network server, a proof of provenance identifier;
transmitting, by the payment network server, the proof of provenance identifier to a proof of provenance server; and
receiving, by the payment network server, an authorization message indicating an approval or denial of the proof of provenance identifier.

11. The method of claim 10, further comprising processing a payment transaction, wherein processing the payment transaction comprises:
receiving, by the payment network server, a transaction request message associated with the proof of provenance identifier;
forwarding, by the payment network server, the transaction request message to an issuer server; and
receiving, by the payment network server, a response indicating an approval or denial of the transaction request message.

12. The method of claim 11, further comprising:
receiving, by the payment network server, the proof of provenance identifier and payment account details for updating a proof of provenance identity associated with the received proof of provenance identifier; and
transmitting, by the payment network server, the received proof of provenance identifier and the payment account details to the proof of provenance server.

13. The method of claim 11, further comprising:
receiving, by the payment network server, a request to reverse the approved transaction request message; and
transmitting, by the payment network server, the request to the issuer server.

14. The method of claim 10, wherein the payment network server is combined with the proof of provenance server.

15. The method of claim 14, further comprising:
receiving, by the proof of provenance server, a request to obtain the proof of provenance identity of the proof of provenance identifier from the payment network server;
determining, by the proof of provenance server, a proof of provenance host associated with the received proof of provenance identifier;
transmitting, by the proof of provenance server, the received proof of provenance identifier to the determined proof of provenance host;
receiving, by the proof of provenance server, the proof of provenance identity associated with the transmitted proof of provenance identifier from the determined proof of provenance host; and
transmitting, by the proof of provenance server, the authorization message indicating the approval of the proof of provenance identifier based on the received proof of provenance identity to the payment network server.

16. The method of claim 14, further comprising:
receiving, by the proof of provenance server, a request to obtain the proof of provenance identity of the proof of provenance identifier from a computing device;
determining, by the proof of provenance server, a proof of provenance host associated with the received proof of provenance identifier;
transmitting, by the proof of provenance server, the received proof of provenance identifier to the determined proof of provenance host;
receiving, by the proof of provenance server, the proof of provenance identity associated with the transmitted proof of provenance identifier from the determined proof of provenance host; and
transmitting, by the proof of provenance server, the received proof of provenance identity to the computing device.

17. The method of claim 14, further comprising:
receiving, by the proof of provenance server, a request to update the proof of provenance identity, the request comprising the proof of provenance identifier and the payment account details;
determining, by the proof of provenance server, a proof of provenance host associated with the received proof of provenance identifier; and
transmitting, by the proof of provenance server, the received request to the determined proof of provenance host.

18. The method of claim 14, further comprising:
receiving, by the proof of provenance server, a request to update a proof of provenance account of a user, the request comprising the proof of provenance identifier; and
updating, by the proof of provenance server, the proof of provenance account based on the proof of provenance identifier.

19. A non-transitory computer readable storage medium,
having computer executable instructions that, when executed by a processor of a payment network server in connection with processing a proof of provenance transaction, cause the processor to:
receive a proof of provenance identifier;
transmit the proof of provenance identifier to a proof of provenance server; and
receive an authorization message indicating an approval or denial of the proof of provenance identifier.

20. The non-transitory computer readable storage medium of claim 19, wherein the executable instructions, when executed by the processor of the payment network server, the method further cause the processor to:
receive a transaction request message associated with the proof of provenance identifier;
forward the transaction request message to an issuer server; and
receive a response indicating an approval or denial of the transaction request message.
